(19) United States
(12) Patent Application Publication
(10) Pub. No.: US 2026/0208106 A1
(43) Pub. Date: Jul. 23, 2026

(54) IMPROVED THREE-WAY CATALYSTS

(71) Applicant: BASF CORPORATION, Florham Park, NJ (US)

(72) Inventors: Yuejin LI, Florham Park, NJ (US); Andreas SUNDERMANN, Heidelberg (DE)

(21) Appl. No.: 19/137,957

(22) PCT Filed: Dec. 12, 2023
(86) PCT No.: PCT/EP2023/085344

§ 371 Date: Jun. 11, 2025

(30) Foreign Application Priority Data
Dec. 13, 2022 (EP) 22213049.4

(51) Int. Cl. B01D 53/94; B01J 37/00; B01J 37/02

(52) U.S. Cl. CPC B01D 53/945; B01J 37/0063; B01J 37/0201; B01D 2255/1021; B01D 2255/1025; B01D 2255/2047; B01D 2255/2063; B01D 2255/2065; B01D 2255/2066; B01D 2255/2068; B01D 2255/20738; B01D 2255/20753

(57) ABSTRACT

A catalyst composition comprising a platinum group metal comprising rhodium, platinum or a combination thereof, a metal-oxide promoter, wherein the metal in the metal-oxide promoter is selected from magnesium, iron, nickel or any combination thereof, and a support, wherein the support is selected from a rare earth metal-oxide doped zirconia solid solution, a ceria-alumina composite, rare earth metal-oxide doped ceria-zirconia solid solution or a combination thereof, wherein the platinum group metal and promoter are co-impregnated on the support or acid-base reactive impregnated on the support. The present invention also provides a process for the preparation of the catalyst composition. The present invention further provides a catalytic article made from the catalyst composition.

### FIELD OF THE INVENTION

The presently claimed invention relates to a three-way catalyst (TWC's). Particularly, the presently claimed invention relates to the three-way catalysts (TWC's) having improved low-temperature (cold-start) activity.

### BACKGROUND OF THE INVENTION

Over the past decades, the demand of platinum group metals (PGMs) for automotive catalyst applications has been consistently increasing due to the implementation of increasingly stringent emissions regulations worldwide. The increased demand of palladium (Pd) and rhodium (Rh) for automotive catalysts has created supply shortage for these two metals. This creates an enormous incentive for the industry to reduce PGM usage and therewith cost in TWC catalysts.

Rh is unique in TWC catalysis, especially in promoting NOx conversion. Like other PGMs, Rh subjects to deactivation after high temperature aging. On an Al₂O₃ support, one major aging mode for Rh is the formation of inactive Rh—Al compounds, which can only be partially restored after a reduction treatment. Pt, on the other hand, is not widely used in modern TWC catalysts because it is more prone to sinter at high temperature, thus rendering low effectiveness for TWC performance.

WO2017/004414 A1 discloses a nitrous oxide (N₂O) removal catalyst composite for treatment of an exhaust stream of an internal combustion engine operating under conditions that are stoichiometric or lean with periodic rich transient excursions. The catalyst composite comprises a N₂O removal catalytic material on a carrier, the catalytic material comprising a platinum group metal (PGM) component supported on a ceria-containing support having a single phase, cubic fluorite crystal structure, wherein the N₂O removal catalytic material is effective to decompose N₂O in the exhaust stream to nitrogen (N₂) and oxygen (O₂) or to reduce N₂O to N₂ and water (H₂O) or carbon dioxide (CO₂).

WO 2015/143191 A1 relates to a layered catalyst composite for an exhaust stream of an internal combustion engine, the layered catalyst composite comprising a catalytic material on a substrate, the catalytic material comprising at least two layers. The first layer comprises rare earth oxide-high surface area refractory metal oxide particles, an alkaline earth metal supported on the rare earth oxide-high surface area refractory metal oxide particles, and at least one first platinum group metal component supported on the rare earth oxide-high surface area refractory metal oxide particles. The second layer comprises a second platinum group metal component supported on a first oxygen storage component (OSC) and/or a first refractory metal oxide support and, optionally, a third platinum group metal supported on a second refractory metal oxide support or a second oxygen storage component.

### OBJECTS OF THE INVENTION

In recent years, the price of Pt is about one half of that of Pd. This provides an incentive and challenge to make Pt more effective for TWC performance after high temperature aging.

Accordingly, it is required to solve this problem by finding out a suitable support, an effective promotor, and a preparation method to improve the efficiency of rhodium and platinum.

The object of the presently claimed invention is to provide a TWC catalyst having a low-temperature (cold-start) activity.

Another object of the presently claimed invention is to provide a TWC catalyst having improved efficiency.

Still another object of the presently claimed invention is to provide the TWC catalyst which use less PGM and thereby reducing the cost.

### SUMMARY OF THE INVENTION

The present invention provides a catalyst composition comprising:
a) a platinum group metal comprising rhodium, platinum, or a combination thereof,
b) a metal-oxide promoter, wherein the metal in the metal-oxide promoter is selected from magnesium, iron, nickel, or any combination thereof, and
c) a support,
   wherein the total amount of the platinum group metal is in the range of 0.1 to 10 wt. %, based on the total weight of the catalyst composition,
   wherein the total amount of the metal-oxide promoter, in an oxidic form is in the range of 0.2 to 6.0 wt. %, based on the total weight of the catalyst composition,
   wherein the total amount of support is in the range of 84 to 99.3 wt. %, based on the total weight of the catalyst composition,
   wherein the support is selected from a rare earth metal-oxide doped zirconia solid solution, a ceria-alumina composite, rare earth metal-oxide doped ceria-zirconia solid solution or a combination thereof,
   wherein the platinum group metal and promoter are co-impregnated on the support or acid-base reactive impregnated on the support.

The present invention also provides a process for the preparation of the catalyst composition. The present invention further provides a catalytic article made from the catalyst composition.

### BRIEF DESCRIPTION OF THE DRAWINGS

In order to provide an understanding of the embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1A illustrates TWC light-off temperatures (T50s) of the samples described in Table 1A (Samples 1, Sample 2A to 11A).

FIG. 1B illustrates TWC light-off temperatures (T50s) of the samples described in Table 1B (Samples 1, Sample 2B to 11B).

FIG. 2 illustrates TWC light-off temperatures (T50s) of the samples described in Table 2 (Samples 12 to 24).

FIG. 3 illustrates TWC light-off temperatures (T50s) of the samples described in Table 3 (Samples 25 to 34).

FIG. 4 illustrates TWC light-off temperatures (T50s) of the samples described in Table 4 (Samples 35-42).

FIG. 5 illustrates TWC light-off temperatures (T50s) of the samples described in Table 5 (Samples 43-45).

FIG. 6 illustrates TWC light-off temperatures (T50s) of the samples described in Table 6 (Samples 46-51).

FIG. 7 illustrates TWC light-off temperatures (T50s) of the samples described in Table 7 (Samples 52-58).

FIG. 8 illustrates oxygen storage capacities measured at 350 and 450° C. for samples described in Table 7 (Samples 52-58).

FIG. 9A is a perspective view of a honeycomb-type substrate carrier which may comprise the catalyst composition in accordance with one embodiment of the presently claimed invention.

FIG. 9B is a partial cross-section view enlarged relative to FIG. 9A and taken along a plane parallel to the end faces of the substrate carrier of FIG. 9A, which shows an enlarged view of a plurality of the gas flow passages shown in FIG. 9A.

FIG. 10 is a cutaway view of a section enlarged relative to FIG. 9A, wherein the honeycomb-type substrate in FIG. 9A represents a wall flow filter substrate monolith.

### DETAILED DESCRIPTION

The presently claimed invention will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

### Definitions

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

In the context of the present invention the term “washcoat” is interchangeably used for “catalyst composition deposited on a substrate in the form of a slurry” which forms one or more layers on a part of the respective substrate. As used herein, the term “washcoat” has its usual meaning in the art of a thin, adherent coating of a catalytic or other material applied to a substrate material. Generally, a washcoat is formed by preparing a slurry containing a certain solid content (e.g., 15-60% by weight) of particles in a liquid vehicle, which is then coated onto a substrate and dried to provide a washcoat layer on the respective substrate.

The term “three-way conversion catalyst” or TWC catalyst refers to a catalyst that simultaneously promotes a) reduction of nitrogen oxides to nitrogen and oxygen; b) oxidation of carbon monoxide to carbon dioxide; and c) oxidation of unburnt hydrocarbons to carbon dioxide and water.

The term “NOx” refers to nitrogen oxide compounds, such as NO and/or NO₂.

As used herein, the term “stream” broadly refers to any combination of flowing gas that may contain solid or liquid particulate matters.

As used herein, the terms “upstream” and “downstream” refer to relative directions according to the flow of an engine exhaust gas stream from an engine towards a tailpipe, with the engine in an upstream location and the tailpipe and any pollution abatement articles and catalysts being downstream from the engine.

The term “close-coupled” refers to a position of one or more catalytic converters which are placed in a proximity to the engine-out manifold.

The term “underfloor” refers to a position of one or more catalytic converters which are placed away from the close-coupled position. Usually, the underfloor catalytic converter is placed in the underfloor of the vehicle body between a close-coupled catalytic convert and a muffler.

The term “co-impregnation” refers to a catalyst preparation method in which two soluble metal salts are mixed to obtain a mixture. The mixture is then impregnated on a support. According to the present invention, soluble platinum group metal salts and soluble promoter metal salts are mixed together to obtain a mixture. This mixture is then impregnated on a support.

The term “acid-base reactive impregnation” refers to a catalyst preparation method, in which a soluble basic platinum group metal precursor is first impregnated on a support material to form a first impregnated support, and then a soluble acidic promotor precursor is impregnated on the first impregnated support to form a second impregnated support. On the second mixture, the acid (promoter precursor) reacts with the base (platinum group metal precursor), resulting in a close interaction between the platinum group metal and the promotor metal and at the same time fixing the metals on the support. Acid-base reactive impregnation can also be carried out in a reverse sequence, i.e., impregnating first the acidic precursor and then the basic precursor. An example of a basic platinum group metal precursor is platinum tetraethanolamine hydroxide. An acidic promotor precursor can be made by mixing a promotor salt solution with an acid. An example of the acid promotor precursor is a mixed solution of iron nitrate and nitric acid, where the amount of nitric acid is about 3% of the support by weight.

The terms “promoter, in an oxide form”, “metal-oxide promoter, in an oxide form”, “promoter, in an oxidic form” and “metal-oxide promoter, in an oxidic form” all refer to a promoter comprising a metal, such as magnesium, iron or nickel, wherein the metal is in the form of the oxide or of one or more of its oxides, such as MgO. The total amount of the metal-oxide promoter is calculated on the basis of the oxide, and for Mg, Fe, and Ni is preferably calculated as MgO, Fe₂O₃, and NiO, respectively, based on the total weight of the catalyst composition.

The term “rare earth metal in an oxide form” refers to a rare earth metal, such as lanthanum, praseodymium, neodymium or yttrium, wherein the rare earth metal is in the form of the oxide or of one or more of its oxides, such as La₂O₃, Pr₂O₃, Nd₂O₃ or Y₂O₃. The total amount of the rare earth metal in an oxide form is calculated on the basis of the oxide, based on the total weight of the catalyst composition. Preferably, total amount of the rare earth metal in an oxide form is calculated as the oxide of the metal in the oxidation state +3.

In one aspect the present invention provides a catalyst composition comprising:
a) a platinum group metal comprising rhodium, platinum, or a combination thereof,
b) a metal-oxide promoter, wherein the metal in the metal-oxide promoter is selected from magnesium, iron, nickel, or any combination thereof, and
c) a support,
   wherein the total amount of the platinum group metal is in the range of 0.1 to 10 wt. %, based on the total weight of the catalyst composition,
   wherein the total amount of the metal-oxide promoter, in an oxidic form is in the range of 0.2 to 6.0 wt. %, based on the total weight of the catalyst composition,
   wherein the total amount of support is in the range of 84 to 99.3 wt. %, based on the total weight of the catalyst composition,
   wherein the support is selected from a rare earth metal-oxide doped zirconia solid solution, a ceria-alumina composite, rare earth metal-oxide doped ceria-zirconia solid solution or a combination thereof,
   wherein the platinum group metal and promoter are co-impregnated on the support or acid-base reactive impregnated on the support.

### Platinum Group Metals:

Preferably, the platinum group metal is rhodium, platinum or a combination of rhodium and platinum.

Preferably, the total amount of the platinum group metal is in the range of 0.1 to 10 wt. %, based on the total weight of the catalyst composition. More preferably, the total amount of the platinum group metal is in the range of 0.1 to 5.0 wt. %, based on the total weight of the catalyst composition. Even more preferably, the total amount of the platinum group metal is in the range of 0.1 to 3.0 wt. %, based on the total weight of the catalyst composition.

In one preferred embodiment, the platinum group metal is rhodium.

Preferably, the amount of rhodium is in the range of 0.1 to 2.0 wt. %, based on the total weight of the catalyst composition. More preferably, the amount of rhodium is in the range of 0.1 to 1.0 wt. %, based on the total weight of the catalyst composition. Most preferably, the amount of rhodium is in the range of 0.2 to 0.5 wt. %, based on the total weight of the catalyst composition.

In another preferred embodiment, the platinum group metal is platinum. Preferably, the amount of platinum is in the range of 0.2 to 4.0 wt. %, based on the total weight of the catalyst composition. More preferably, the amount of platinum is in the range of 0.5 to 3.0 wt. %, based on the total weight of the catalyst composition. Most preferably, the amount of platinum is in the range of 1.0 to 2.0 wt. %, based on the total weight of the catalyst composition.

In still another preferred embodiment, the platinum group metal is a combination of rhodium and platinum. Preferably, the weight ratio of rhodium to platinum is 1:0.5 to 1:10. More preferably, the weight ratio of rhodium to platinum is 1:2 to 1:5. Preferably, the amount of rhodium is in the range of 0.1 to 2.0 wt. %, based on the total weight of the catalyst composition. More preferably, the amount of rhodium is in the range of 0.1 to 1.0 wt. %, based on the total weight of the catalyst composition. Most preferably, the amount of rhodium is in the range of 0.2 to 0.5 wt. %, based on the total weight of the catalyst composition. Preferably, the amount of platinum is in the range of 0.2 to 4.0 wt. %, based on the total weight of the catalyst composition. More preferably, the amount of platinum is in the range of 0.5 to 3.0 wt. %, based on the total weight of the catalyst composition. Most preferably, the amount of platinum is in the range of 1.0 to 2.0 wt. %, based on the total weight of the catalyst composition.

### Promoter:

The promoter is a metal-oxide promoter. More specifically, the promoter comprises a metal which is in its oxidic form. Preferably, the metal in the metal-oxide promotor is selected from magnesium, iron, nickel, or any combination thereof. More preferably, the metal in the metal-oxide promoter is magnesium or iron.

Preferably, the amount of the metal-oxide promoter, is in the range of 0.2 to 6.0 wt. %, based on the total weight of the catalyst composition. More preferably, the total amount of the metal-oxide promoter is in the range of 0.2 to 5 wt. %, more preferably in the range of 0.2 to 4.0 wt. %, based on the total weight of the catalyst composition. More preferably, the amount of the metal-oxide promoter is in the range of 0.2 to 3.0 wt. %, more preferably in the range of 0.2 to 2.0 wt. %, and more preferably in the range of 0.5 to 2.0 wt. %, based on the total weight of the catalyst composition. More preferably, the amount of the metal-oxide promoter is calculated on the basis of the oxides of magnesium, iron, nickel, even more preferably calculated as MgO, Fe₂O₃, and NiO, respectively.

More preferably, the amount of the metal-oxide promoter, e.g. the promoter in an oxidic form, is in the range of 1.0 to 2.0 wt. %, based on the total weight of the catalyst composition.

In one preferred embodiment, the metal in the metal-oxide promoter is magnesium. Preferably, the amount the metal-oxide promoter comprising magnesium, is in the range of 0.2 to 6.0 wt. %, more preferably in the range of 0.2 to 5 wt. %, more preferably in the range of 0.2 to 4.0 wt. %, more preferably is in the range of 0.2 to 3.0 wt. %, based on the total weight of the catalyst composition. More preferably, the amount of the metal-oxide promoter comprising magnesium is in the range of 1.0 to 2.0 wt. %, based on the total weight of the catalyst composition. The amount of the metal-oxide promoter is calculated on the basis of the oxide of magnesium, preferably calculated as MgO.

In one preferred embodiment, the metal in the metal-oxide promoter is iron. Preferably, the amount of the metal-oxide promoter comprising iron is in the range of 0.2 to 6.0 wt. %, more preferably in the range of 0.2 to 5 wt. %, more preferably in the range of 0.2 to 4.0 wt. %, more preferably is in the range of 0.2 to 3.0 wt. %, based on the total weight of the catalyst composition. More preferably, the amount of the metal-oxide promoter comprising iron is in the range of 1.0 to 2.0 wt. %, based on the total weight of the catalyst composition. Preferably, the iron oxide is iron (III) oxide. The amount of the metal-oxide promoter is calculated on the basis of the oxide of iron, preferably calculated as Fe₂O₃.

### Support:

A “support” in a catalytic material or catalyst composition or catalyst washcoat refers to a material that receives metals (e.g., PGMs), stabilizers, promoters, binders, and the like through precipitation, association, dispersion, impregnation, or other suitable methods.

The term “supported” throughout this application has the general meaning as in the field of heterogenous catalysis. In general, the term “supported” refers to an affixed catalytically active species or its respective precursor to a support material. The support material may be inert or participate in the catalytic reaction. Commonly supported catalysts are prepared by impregnation methods, ion exchange methods or co-precipitation methods with optional subsequent calcination.

Preferably, the support is selected from a rare earth metal-oxide doped zirconia solid solution, a ceria-alumina composite, rare earth metal-oxide doped ceria-zirconia solid solution or a combination thereof. More preferably, the support is a rare earth metal-oxide doped zirconia solid solution.

The term “rare earth metal-oxide doped support” means one or more rare earth elements are incorporated into the bulk structure or decorated on the surface of a support material.

The substitution of a minor fraction of the cations in the host oxide lattice with external metal ions is referred as doping, i.e. in doping, the dopant element/s replace the metal element in the parent structure without changing the type of crystal phase. However, the lattice parameter (crystallinity or surface area) may change due to the size difference between dopant element and the metal element of the parent structure. For example, when La is incorporated in a monoclinic ZrO₂ structure the composite has the same structure as monoclinic ZrO₂. However, due to smaller the smaller ionic radius of La (vs. Zr) its lattice parameters (unit cell volume) are slightly smaller. The degree of shrinkage (or shift of XRD 2Theta position) depends on the content of the La dopant.

The term “solid solution” refers to a homogenous mixture of two different kinds of atoms in solid state and have a single crystal structure.

Preferably, the rare earth metal is selected from lanthanum, praseodymium, neodymium, yttrium, or any combination thereof. More preferably, the rare earth metal is lanthanum. More preferably, the rare earth metal, in an oxide form is La₂O₃, Pr₂O₃, Nd₂O₃ or Y₂O₃, even more preferably La₂O₃.

Most preferably, the support is a lanthanum oxide doped zirconia solid solution.

Preferably, the amount of the support is in the range of 84 to 99.3 wt. %, based on the total weight of the catalyst composition. More preferably, the amount of the support is in the range of 91 to 99 wt. %, based on the total weight of the catalyst composition. Even more preferably, the amount of support is in the range of 95 to 98 wt. %, based on the total weight of the catalyst composition.

Preferably, the amount of the rare earth metal, in an oxide form, in the rare earth metal-oxide doped support is in the range of 2.0 to 20 wt. %, based on the total weight of the rare earth metal-oxide doped support. More preferably, the amount of the rare earth metal, in an oxide form, in the rare earth metal-oxide doped support is in the range of 5.0 to 15 wt. %, more preferably in the range of 7.0 to 13 wt. % in the range of 8.0 to 11 wt. %, based on the total weight of the rare earth doped support. The total amount of the rare earth metal in an oxide form is calculated on the basis of the oxide, based on the total weight of the catalyst composition. Preferably, total amount of the rare earth metal in an oxide form is calculated as the oxide of the metal in the oxidation state +3.

Preferably, the amount of rare earth metal, in an oxide form, in the rare earth metal-oxide doped zirconia solid solution is in the range of 5.0 to 15 wt. %, based on the total weight of the rare earth metal-oxide doped zirconia solid solution and the amount of zirconia in the rare earth metal-oxide doped zirconia solid solution is in the range of 85 to 95 wt. %, based on the total weight of the rare earth metal-oxide doped zirconia solid solution.

More preferably, the amount of rare earth metal, in an oxide form, in the rare earth metal-oxide doped zirconia solid solution is in the range of 7.0 to 12.0 w t.%, based on the total weight of the rare earth metal-oxide doped zirconia solid solution and the amount of zirconia in the rare earth metal-oxide doped zirconia solid solution is in the range of 88 to 93 wt. %, based on the total weight of the rare earth metal-oxide doped zirconia solid solution.

### Rare Earth Metal-Oxide Doped Zirconia Solid Solution

Rare earth metal-oxide doped zirconia solid solution is defined as a crystalline zirconia material that incorporates one or more rare earth metals into its bulk structure, forming a single crystallographic phase as measured by X-ray diffraction spectrometer.

Preferably, the amount of the rare earth metal-oxide doped zirconia solid solution present in the catalyst composition is 84 to 99.3 wt. %, based on the total weight of the catalyst composition. More preferably, the amount of the rare earth metal-oxide doped zirconia solid solution present in the catalyst composition is 91 to 99 wt. %, based on the total weight of the catalyst composition.

Preferably, the amount of rare earth metal, in oxidic form, in the rare earth metal-oxide doped zirconia solid solution is in the range of 5.0 to 15 wt. %, based on the total weight of the rare earth metal doped zirconia solid solution and the amount of zirconia in the rare earth metal doped zirconia solid solution is in the range of 85 to 95 wt. %, based on the total weight of the rare earth metal-oxide doped zirconia solid solution. More preferably, the amount of rare earth metal, in oxidic form, in the rare earth metal-oxide doped zirconia solid solution is in the range of 7.0 to 12 wt. %, based on the total weight of the rare earth metal-oxide doped zirconia solid solution and the amount of zirconia in the rare earth metal-oxide doped zirconia solid solution is in the range of 88 to 93 wt. %, based on the total weight of the rare earth metal-oxide doped zirconia solid solution.

### Ceria-Alumina Composite

Ceria-alumina composite is a composite in which CeO₂ is distributed on the surface of alumina and/or in the bulk as particles and/or nano clusters. Each oxide may have its distinct chemical and solid physical state. The surface CeO₂ modification of alumina can be in the form of discrete moieties (particles or clusters) or in the form of a layer of ceria that covers the surface of alumina partially or completely.

Preferably, the amount of the ceria-alumina composite present in the catalyst composition is in the range of 84 to 99.3 wt. %, based on the total weight of the catalyst composition. More preferably, the amount of the ceria-alumina composite present in the catalyst composition is in the range of 91 to 96 wt. %, based on the total weight of the catalyst composition.

The amount of CeO₂ (cerium oxide) in the ceria-alumina composite present in the catalyst composition is preferably 5.0 to 50 wt. %, based on the total weight of the ceria-alumina composite in the catalyst composition. More preferably, the CeO₂ in the ceria-alumina composite present in the catalyst composition is 10 to 30 wt. %, based on the total weight of the ceria-alumina composite in the catalyst composition.

The amount of Al₂O₃ (aluminium oxide) in the ceria-alumina composite present in the catalyst composition is preferably 50 to 95 wt. %, based on the total weight of the ceria-alumina composite in the catalyst composition. More preferably, the Al₂O₃ (aluminium oxide) in the ceria-alumina composite present in the catalyst composition is 70 to 90 wt. %, based on the total weight of the ceria-alumina composite in the catalyst composition.

### Rare Earth Metal Doped Ceria-Zirconia Solid Solution

Rare earth metal-oxide doped ceria-zirconia solid solution is defined as a ceria-zirconia solid solution that incorporates one or more rare earth metals into its bulk structure, forming a single crystallographic phase as measured by X-ray diffraction spectrometer.

Preferably, the amount of the rare earth metal-oxide doped ceria-zirconia solid solution present in the catalyst composition is 84 to 99.3 wt. %, based on the total weight of the catalyst composition. More preferably, the amount of the rare earth metal-oxide doped ceria-zirconia solid solution present in the catalyst composition is 91 to 96 wt. %, based on the total weight of the catalyst composition.

Preferably, ceria (calculated as CeO₂) in the rare earth metal-oxide doped ceria-zirconia solid solution present in the catalyst composition is present in an amount of 15 to 85 wt. %, based on the total weight of the rare earth doped ceria-zirconia solid solution present in the catalyst composition and zirconia (calculated as ZrO₂) in the rare earth metal-oxide doped ceria-zirconia solid solution present in the catalyst composition is present in an amount of 10 to 80 wt. %, based on the total weight of the rare earth metal-oxide doped ceria-zirconia solid solution present in the catalyst composition.

More preferably, ceria (calculated as CeO₂) in the rare earth metal-oxide doped ceria-zirconia solid solution present in the catalyst composition is present in an amount of 30 to 50 wt. %, based on the total weight of the rare earth metal-oxide doped ceria-zirconia solid solution present in the catalyst composition and zirconia (calculated as ZrO₂) in the rare earth metal-oxide doped ceria-zirconia solid solution present in the catalyst composition is present in an amount of 40 to 60 wt. %, based on the total weight of the rare earth metal-oxide doped ceria-zirconia solid solution present in the catalyst composition.

Preferably, the amount of rare earth metal, in oxidic form, in the rare earth metal-oxide doped ceria-zirconia solid solution is in the range of 5.0 to 15 wt. %, based on the total weight of the rare earth metal-oxide doped ceria-zirconia solid solution.

More preferably, the amount of rare earth metal, in oxidic form, in the rare earth metal-oxide doped ceria-zirconia solid solution is in the range of 8.0 to 12 wt. %, based on the total weight of the rare earth metal-oxide doped ceria-zirconia solid solution.

### Preparation of the Catalyst Composition

In one embodiment the catalyst composition is prepared by a co-impregnation technique. Preparation of catalyst composition comprises co-impregnation of a platinum group metal (PGM) salt and a metal-oxide promotor salt on a support. The platinum group metal salt and the metal-oxide promoter salt are mixed to obtain a mixture. Preferably, the platinum group metal salt and the metal-oxide promotor salt share the same type of anion. Preferably, the salt is selected from nitrate, acetate or chloride of platinum group metal and metal-oxide promotor. More preferably, the salt is nitrate. The mixture is co-impregnated on a support to obtain an impregnated support. Preferably, the support is selected from a rare earth metal-oxide doped zirconia solid solution, a ceria-alumina composite, rare earth metal-oxide doped ceria-zirconia solid solution or a combination thereof. More preferably, the support is a rare earth metal-oxide doped zirconia solid solution. The impregnated support is subjected to calcination to obtain the catalyst composition. Preferably, the calcination is carried out at a temperature ranging from 400 to 600° C., preferably for 1.0 to 4.0 hours.

Preferably, the process comprises a pre-step of dispersing the impregnated support in deionized water at about 30% to 50% solid content followed by milling and drying at 100° C. to obtain a catalyst composition in a powder form.

In another embodiment, the platinum group metal and metal-oxide promotor metal are deposited on a support by acid-base reactive impregnation of a platinum group metal precursor and a promoter metal salt. More preferably, the process comprises:
impregnating a basic platinum precursor solution on the support selected from rare earth metal-oxide doped zirconia solid solution, a ceria-alumina composite, rare earth metal-oxide doped ceria-zirconia solid solution or a combination thereof to obtain a first impregnated support;
impregnating an acidified metal-oxide promotor salt solution on the first impregnated support to obtain a second impregnated support; and
calcination of the second impregnated support to obtain the catalyst composition.

The term “basic platinum precursor solution” is a platinum complex hydroxide solution, where the platinum complex is a platinum cation coordinated with basic ligands. Examples of platinum complex hydroxide solution are solutions of platinum (II) tetraamine hydroxide, whereas the amine ligands in the complex can be any ammonia derivatives, including ammonia and any alkyl amines. The amines can be primary amines, where one of the three hydrogen atoms in ammonia is replaced by an alkyl group, secondary amines, where two of the three hydrogen atoms in ammonia are replaced by an alkyl group, or tertiary amines, where all three hydrogen atoms in ammonia are replaced by an alkyl group. Examples of the amines include methylamine, dimethylamine, trimethylamine, ethylamine, ethanolamine.

Preferably, the basic platinum precursor solution is a solution of platinum (II) tetraethanolamine hydroxide.

The term “acidified metal-oxide promotor salt solution” is a mixture of a metal-oxide promoter salt solution and acid solution, wherein the combined solution has a pH of less than 4.0. The metal-oxide promoter salt solution is the metal-oxide promotor precursor salt solution, such as Fe (III) nitrate. The acid can be any acid. Examples include nitric acid, hydrochloric acid, and acetic acid.

The platinum basic platinum precursor is first impregnated on the support to obtain a first impregnated support. An acidified metal-oxide promotor salt solution is impregnated on the first impregnated support to obtain a second impregnated support. The acidic metal-oxide promotor salt solution, respectively the acidic metal-oxide promotor salt reacts with the basic platinum group metal precursor deposited on the support and as a result of this acid-base reaction, the platinum group metal and the metal of the metal-oxide promotor are situated in a close proximity and affixed on the support. Preferably, the anion of the metal-oxide promotor salt is selected from nitrate, acetate or chloride. More preferably, the anion of metal-oxide promotor salt is nitrate. The metal-oxide promotor salt solution is acidified by adding an acid with acid quantity of about 2.0 to 5.0% of the support weight to adjust the pH to 4.0 or less. Preferably, the support is selected from a rare earth metal-oxide doped zirconia solid solution, a ceria-alumina composite, rare earth metal-oxide doped ceria-zirconia solid solution or a combination thereof. More preferably, the support is a ceria-alumina composite. The second impregnated support is subjected to calcination to obtain a catalyst composition. Preferably, the calcination is carried out at a temperature ranging from 400 to 600° C., preferably for 1.0 to 4.0 hours.

Preferably, the process comprises a pre-step of dispersing the second impregnated support in deionized water at about 30% to 50% solid content followed by milling and drying at 100° C. to obtain a catalyst composition in a powder form.

### Catalytic Article:

In another aspect, the present invention also provides a catalytic article, the catalytic article comprising the catalyst composition according to the present invention, deposited on at least parts of a substrate, the catalyst composition comprises a platinum group metal comprising rhodium, platinum or a combination thereof, a promoter selected from magnesium, iron, nickel or any combination thereof; and a support selected from a rare earth metal doped zirconia solid solution, a ceria-alumina composite, rare earth metal doped ceria-zirconia solid solution or a combination thereof,
wherein the amount of the platinum group metal is in the range of 0.1 to 10 wt. %, based on the total weight of the catalyst composition,
wherein the amount of the promoter is in the range of 0.2 to 6.0 wt. %, based on the total weight of the catalyst composition,
wherein the amount of support is in the range of 84 to 99.3 wt. %, based on the total weight of the catalyst composition.

Preferably, the catalytic article is a single layered article, wherein the catalyst composition according to the present invention is deposited as a single layer on at least parts of the substrate.

Preferably, the amount of rhodium deposited on the substrate is in the range of 1.0 to 20 g/ft³, based on the total volume of substrate. More preferably, the amount of rhodium is in the range of 2.0 to 10 g/ft³, based on the total volume of the substrate. Most preferably, the amount of rhodium is in the range of 4.0 to 8.0 g/ft³, based on the total volume of the substrate.

Preferably, the amount of platinum is in the range of 2.0 to 100 g/ft³, based on the total volume of the substrate. More preferably, the amount of platinum is in the range of 5.0 to 80 g/ft³, based on the total volume of the substrate. Most preferably, the amount of platinum is in the range of 10 to 50 g/ft³, based on the total volume of the substrate.

Preferably, the weight ratio of rhodium to platinum is 1:0.5 to 1:10. More preferably, the weight ratio of rhodium to platinum is 1:2 to 1:5.

Preferably, the catalytic article is a bi-layered article comprising a first layer, a second layer and a substrate, wherein the first layer is deposited on at least parts of the substrate and the second layer is deposited on at least parts of the first layer and/or at least on parts of the substrate, wherein the first layer comprises platinum, palladium, rhodium or any combination thereof, wherein the second layer comprises the catalyst composition according to the present invention comprising a platinum group metal.

In the context of the present invention, the term “first layer” is interchangeably used as ‘bottom layer’ or ‘bottom coat’ or ‘bottom washcoat’. In the context of the present invention, the term “second layer” is interchangeably used as ‘top layer’ or ‘topcoat’ or ‘top washcoat’.

Preferably, the total amount of platinum, palladium, rhodium or any combination thereof in the catalytic article is in the range of 5.0 to 300 g/ft³, based on the total volume of substrate. More preferably, the total amount of the platinum, palladium, rhodium, or any combination thereof in the catalytic article is in the range of 20 to 200 g/ft³, based on the total volume of the substrate.

Preferably, the total amount of platinum, palladium, rhodium, or any combination thereof in the first layer is in the range of 10 to 200 g/ft³, based on the total volume of substrate. More preferably, the total amount of the platinum, palladium, rhodium, or any combination thereof in the catalytic article is in the range of 30 to 150 g/ft³, based on the total volume of the substrate.

Preferably, the total amount of the platinum group metal/s in the second layer is in the range of 1.0. to 150 g/ft³, based on the total volume of the substrate. More preferably, the total amount of the platinum group metal/s in the second layer is in the range of 2.0 to 100 g/ft³, based on the total volume of the substrate.

### Substrate:

Substrate of the catalyst of the presently claimed invention may be constructed of any material typically used for preparing automotive catalysts. In a preferred embodiment, the substrate is a ceramic substrate, metal substrate, ceramic foam substrate, or a woven fiber substrate. In a more preferred embodiment, the substrate is a ceramic or a metal monolithic honeycomb structure.

The substrate provides a plurality of wall surfaces upon which the catalytic layer/s or washcoat described herein above are applied and adhered, thereby acting as a carrier for the catalytic material.

Preferable metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g., 10-25 wt. % of chromium, 3-8% of aluminium, and up to 20 wt. % of nickel. The alloys may also contain small or trace amounts of one or more metals such as manganese, copper, vanadium, titanium, and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Preferable ceramic materials used to construct the substrate may include any suitable refractory material, e.g., cordierite, silicon carbide, aluminum titanate, mullite, cordierite-alumina, silicon nitride, zircon mullite, spodumene, alumina-silica magnesia, zircon silicate, sillimanite, magnesium silicates, zircon, petalite, alumina, aluminosilicates, and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially available flow-through substrate is a cordierite substrate having 400 cpsi and a wall thickness of 6 mil, or 600 cpsi and a wall thickness of 4 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminium-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

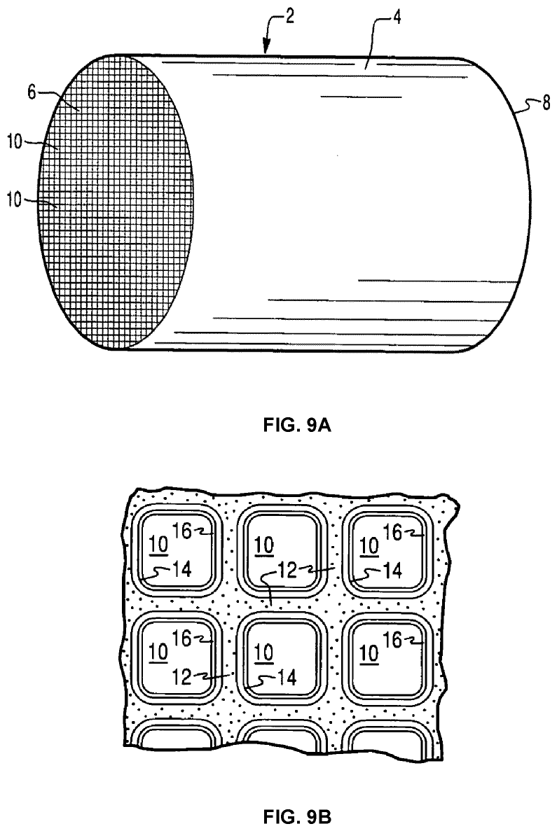

FIGS. 9A and 9B illustrate an exemplary substrate 2 in the form of a flow-through substrate coated with washcoat compositions/catalytic layer/s as described herein. Referring to FIG. 9A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 9B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 9B, walls 12 are so dimensioned and configured that gas flow passages 10 have a substantially regular polygonal shape. As shown, the washcoat compositions/catalytic layers can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

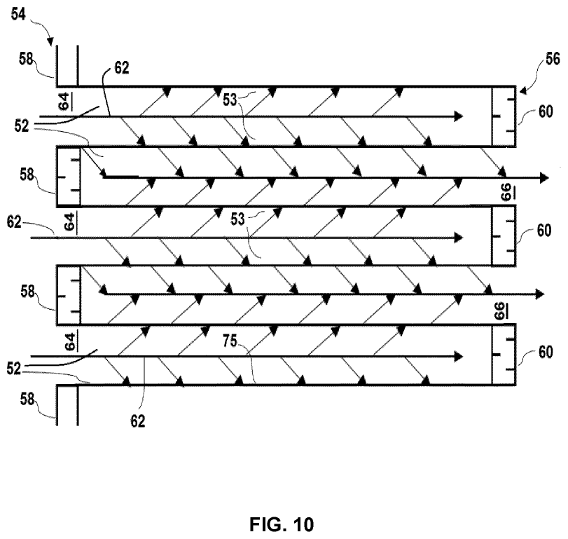

FIG. 10 illustrates an exemplary substrate 2 in the form of a wall flow filter substrate coated with a washcoat composition as described herein. As seen in FIG. 10, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist of all, or in part, of the catalytic material. This invention includes the use of one or more layers of catalytic material on the inlet and/or outlet walls of the element.

### Washcoat/s on Substrate:

The substrate is coated with the catalyst composition which covers 50 to 100% of length of the substrate. Preferably, the catalyst composition covers 70 to 100% of the length of the substrate and more preferably, the catalyst composition covers 90 to 100% of length of the substrate. Most preferably, the catalyst composition covers the whole length or the whole accessible surface area of the substrate.

The term “accessible surface” refers to the surface of the substrate which can be covered with the conventional coating techniques used in the field of catalyst preparation like impregnation techniques.

### Preparation of the Catalytic Article:

Preferably, the single layer catalytic article is prepared by depositing the catalyst composition on at least parts of the substrate.

Preferably, the bi-layered catalytic article is prepared by depositing the first layer on at least parts of the substrate and depositing the second layer on at least parts of the first layer and/or at least on parts of the substrate. Preferably, the first layer is prepared in the form of a first slurry by using platinum, palladium, rhodium, or any combination thereof and support material/s.

Preferably, the support is selected from alumina, lanthanum doped alumina, barium doped alumina, ceria, ceria-alumina composite, and ceria-zirconia solid solution.

Preferably, the second layer is prepared in the form of a second slurry by using the catalyst composition according to the present invention.

The step of preparing the slurry comprises a technique selected from incipient wetness impregnation, incipient wetness co-impregnation, incipient wetness sequential impregnation and post-addition.

Incipient wetness impregnation techniques, also called capillary impregnation or dry impregnation are commonly used for the synthesis of heterogeneous materials, i.e., catalysts.

Typically, a metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying.

The support particles are typically dry enough to absorb substantially all of the solution to form a moist solid. Aqueous solutions of water-soluble compounds or complexes of the active metal are typically utilized, such as rhodium chloride, rhodium nitrate (e.g., Rh (NO)₃ and salts thereof), rhodium acetate, or combinations thereof where rhodium is the active metal; palladium nitrate, palladium tetra amine nitrate, palladium acetate, or combinations thereof where palladium is the active metal; and platinum nitrate, platinum acetate, or combination thereof where platinum is the active metal. A platinum amine hydroxide may also be used as a platinum precursor for impregnation. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 min to 3 hours. The above process can be repeated as needed to reach the desired level of active metal impregnation.

### Substrate Coating:

The above-noted three-way conversion catalysts are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, colloidal ceria-zirconia, associative thickeners, and/or surfactants (including anionic, cationic, non-ionic, or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12. More typically, a pH of a slurry is about 3.0 to 6.0. The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 10 to about 40 microns, preferably 10 to about 30 microns, more preferably about 10 to about 15 microns. The D₉₀ is determined using a dedicated particle size analyzer. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. E.g., the catalyst substrate is dipped one or more times in the slurry or otherwise coated with the slurry. Thereafter, the coated substrate is dried at an elevated temperature (e.g., 100-150° C.) for a period of time (e.g., 10 min-3.0 hours) and then calcined by heating, e.g., at 400-700° C., typically for about 10 minutes to about 3 hours. Following drying and calcining, the final washcoat coating layer is viewed as essentially solvent-free.

After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

The coated substrate can be aged, by subjecting the coated substrate to heat treatment. E.g., aging is done at a temperature of about 850° C. to about 1050° C. in the presence of steam under gasoline engine exhaust conditions for 50-300 hours. Aged catalyst articles are thus provided according to present invention. The effective support material such as ceria-alumina composites maintains a high percentage (e.g., about 50-100%) of their pore volumes upon aging (e.g., at about 850° C. to about 1050° C. in the presence of steam for about 50-300 hours aging).

Aspects of the presently claimed invention are more fully illustrated by the following examples, which are set forth to illustrate certain aspects of the present invention and are not to be construed as limiting thereof.

### Example 1A: Preparation of Catalyst Compositions with 0, 1%, 2% and 3% of Promoter by Co-Impregnation Method

Various catalyst compositions were prepared as listed in Table 1A. The composition mainly comprises 0.5 wt. % Rh on a La₂O₃/ZrO₂ (9% La₂O₃, 91% ZrO₂) support, designated as LZ, and a base metal additive (promoter).

Sample 1 is an additive-free Rh reference catalyst, which was prepared by impregnating Rh nitrate solution on La₂O₃/ZrO₂ (9% La₂O₃, 91% ZrO₂) support to achieve a Rh loading of 0.5% by weight after calcination. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. The catalyst so obtained is designated as fresh catalyst.

Sample 2A was prepared by co-impregnating a mixed nitrate solution of Rh and Al on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 1% Al₂O₃ by weight. The catalyst so obtained is designated as fresh catalyst.

Sample 3A was prepared by co-impregnating a mixed nitrate solution of Rh and Mg on LZ. The remaining process of sample 2A was repeated. After calcination the catalyst contains 0.5% Rh by weight and 1% MgO by weight. The catalyst so obtained is designated as fresh catalyst.

Sample 4A was prepared by co-impregnating a mixed nitrate solution of Rh and Fe on LZ. The remaining process of sample 2A was repeated. After calcination the catalyst contains 0.5% Rh by weight and 1% Fe₂O₃ by weight. The catalyst so obtained is designated as fresh catalyst.

Sample 5A was prepared by co-impregnating a mixed nitrate solution of Rh and Ni on LZ. The remaining process of sample 2A was repeated. After calcination the catalyst contains 0.5% Rh by weight and 1% NiO by weight. The catalyst so obtained is designated as fresh catalyst.

Sample 6A was prepared by co-impregnating a mixed nitrate solution of Rh and Sn on LZ. The remaining process of sample 2A was repeated. After calcination the catalyst contains 0.5% Rh by weight and 1% SnO₂ by weight. The catalyst so obtained is designated as fresh catalyst.

Sample 7A was prepared by co-impregnating a mixed nitrate solution of Rh and Ce on LZ. The remaining process of sample 2A was repeated. After calcination the catalyst contains 0.5% Rh by weight and 3% CeO₂ by weight. The catalyst so obtained is designated as fresh catalyst.

Sample 8A was prepared by first impregnating Ba acetate solution on LZ, drying at 110° C. for 2 hours, and then impregnating Rh nitrate solution. The remaining process of sample 2A was repeated. After calcination the catalyst contains 0.5% Rh by weight and 3% BaO by weight. The catalyst so obtained is designated as fresh catalyst.

Sample 9A was prepared by co-impregnating a mixed nitrate solution of Rh and Y on LZ. The remaining process of sample 2A was repeated. After calcination the catalyst contains 0.5% Rh by weight and 2% Y₂O₃ by weight. The catalyst so obtained is designated as fresh catalyst.

Sample 10A was prepared by co-impregnating a mixed nitrate solution of Rh and Nd on LZ. The remaining process of sample 2A was repeated. After calcination the catalyst contains 0.5% Rh by weight and 2% Nd₂O₃ by weight. The catalyst so obtained is designated as fresh catalyst.

Sample 11A was prepared by co-impregnating a mixed nitrate solution of Rh and Pr on LZ. The remaining process of sample 2A was repeated. After calcination the catalyst contains 0.5% Rh by weight and 2% PrO₁ by weight. The catalyst so obtained is designated as fresh catalyst.

TABLE 1A
Catalyst compositions with 0.5% Rh and various
promotors prepared using co-impregnation method

| Sample | | Rh | | Additive |
|---|---|---|---|---|
| ID | Sample Name | (wt. %) | Support | (promoter) |
| 1 | 0.5Rh/LZ | 0.5 | 9% La₂O₃, 91% ZrO₂ | N/A |
| 2A | 0.5Rh-1Al/LZ | 0.5 | 9% La₂O₃, 91% ZrO₂ | 1% Al₂O₃ |
| 3A | 0.5Rh-1Mg/LZ | 0.5 | 9% La₂O₃, 91% ZrO₂ | 1% MgO |
| 4A | 0.5Rh-1Fe/LZ | 0.5 | 9% La₂O₃, 91% ZrO₂ | 1% Fe₂O₃ |
| 5A | 0.5Rh-1Ni/LZ | 0.5 | 9% La₂O₃, 91% ZrO₂ | 1% NiO |
| 6A | 0.5Rh-1Sn/LZ | 0.5 | 9% La₂O₃, 91% ZrO₂ | 1% SnO₂ |
| 7A | 0.5Rh-3Ce/LZ | 0.5 | 9% La₂O₃, 91% ZrO₂ | 3% CeO₂ |
| 8A | 0.5Rh-3Ba/LZ | 0.5 | 9% La₂O₃, 91% ZrO₂ | 3% BaO |
| 9A | 0.5Rh-2Y/LZ | 0.5 | 9% La₂O₃, 91% ZrO₂ | 2% Y₂O₃ |
| 10A | 0.5Rh-2Nd/LZ | 0.5 | 9% La₂O₃, 91% ZrO₂ | 2% Nd₂O₃ |
| 11A | 0.5Rh-2Pr/LZ | 0.5 | 9% La₂O₃, 91% ZrO₂ | 2% Pr₆O₁₁ |

### Example 1B: Preparation of Catalyst Compositions with 0, 1%, 2% and 3% of Promoter by Sequential Impregnation Method. (Comparative Examples)

The catalyst compositions listed in Table 1A are also prepared using sequential impregnation method, which are listed in Table 1B.

Sample 2B was prepared by first impregnating aluminum nitrate solution on LZ, followed by a calcination at 600° C. for 2 hours in air. The resulting material was further impregnated with rhodium nitrate solution. The so obtained material was then dispersed in deionized water at about 30% solid content, milled for 10 min at 400 rpm, and then dried at 100° C. to obtained catalyst powder. The obtained powder was calcined at 550° C. in air for 2 hours, crashed and sieved to 250-500 mm. The catalyst so obtained is designated as fresh catalyst. The catalyst contains 0.5% Rh by weight and 1% Al₂O₃ by weight after calcination.

Sample 3B was prepared by first impregnating magnesium nitrate solution on LZ, followed by a calcination at 600° C. for 2 hours in air. The resulting material was further impregnated with rhodium nitrate solution. The so obtained material was then dispersed in deionized water at about 30% solid content, milled for 10 min at 400 rpm, and then dried at 100° C. to obtained catalyst powder. The obtained powder was calcined at 550° C. in air for 2 hours, crashed and sieved to 250-500 mm. The catalyst so obtained is designated as fresh catalyst. The catalyst contains 0.5% Rh by weight and 1% MgO by weight after calcination.

Sample 4B was prepared like sample 3B except that iron (III) nitrate solution is used instead of magnesium nitrate solution. The catalyst contains 0.5% Rh by weight and 1% Fe₂O₃ by weight after calcination.

Sample 5B was prepared like sample 3B except that nickel nitrate solution is used instead of magnesium nitrate solution. The catalyst contains 0.5% Rh by weight and 1% NiO by weight after calcination.

Sample 6B was prepared like sample 3B except that tin oxalate solution is used instead of magnesium nitrate solution. The catalyst contains 0.5% Rh by weight and 1% SnO₂ by weight after calcination.

Sample 7B was prepared like sample 3B except that cerium nitrate solution on is used instead of magnesium nitrate solution. The catalyst contains 0.5% Rh by weight and 3% CeO₂ by weight after calcination.

Sample 8B was prepared like sample 3B except that barium acetate solution is used instead of magnesium nitrate solution. The catalyst contains 0.5% Rh by weight and 3% BaO by weight after calcination.

Sample 9B was like sample 3B except that yttrium nitrate solution is used instead of magnesium nitrate solution. The catalyst contains 0.5% Rh by weight and 2% Y₂O₃ by weight after calcination.

Sample 10B was prepared like sample 3B except that neodymium nitrate solution is used instead of magnesium nitrate solution. The catalyst contains 0.5% Rh by weight and 2% Nd₂O₃ by weight after calcination.

Sample 11B was prepared like sample 3B except that praseodymium nitrate solution is used instead of magnesium nitrate solution. The catalyst contains 0.5% Rh by weight and 2% Pr₆O₁₁ by weight after calcination.

TABLE 1B
Catalyst compositions with 0.5% Rh and various promotors prepared using sequential
impregnation method

| Sample | | Rh | | |
|---|---|---|---|---|
| ID | Sample Name | (wt. %) | Additive | Preparation method |
| 1 | 0.5Rh/LZ | 0.5 | N/A | Rh impregnation |
| 2B | 0.5Rh/1Al/LZ | 0.5 | 1% Al₂O₃ | Sequential impregnation of Al and then Rh |
| 3B | 0.5Rh/1Mg/LZ | 0.5 | 1% MgO | Sequential impregnation of Mg and then Rh |
| 4B | 0.5Rh/1Fe/LZ | 0.5 | 1% Fe₂O₃ | Sequential impregnation of Fe and then Rh |
| 5B | 0.5Rh/1Ni/LZ | 0.5 | 1% NiO | Sequential impregnation of Ni and then Rh |
| 6B | 0.5Rh/1Sn/LZ | 0.5 | 1% SnO₂ | Sequential impregnation of Sn and then Rh |
| 7B | 0.5Rh/3Ce/LZ | 0.5 | 3% CeO₂ | Sequential impregnation of Ce and then Rh |
| 8B | 0.5Rh/3Ba/LZ | 0.5 | 3% BaO | Sequential impregnation of Ba and then Rh |
| 9B | 0.5Rh/2Y/LZ | 0.5 | 2% Y₂O₃ | Sequential impregnation of Y and then Rh |
| 10B | 0.5Rh/2Nd/LZ | 0.5 | 2% Nd₂O₃ | Sequential impregnation of Nd and then Rh |
| 11B | 0.5Rh/2Pr/LZ | 0.5 | 2% Pr₆O₁₁ | Sequential impregnation of Pr and then Rh |

LZ is the catalyst support, which comprising of 9% La₂O₃ and 91% ZrO₂.

### Example 2: Preparation of Catalyst Compositions with 0, 0.25, 0.5, 1% and 1.5% of Promoter

Table 2 lists catalyst compositions with 0.5% Rh on LZ and a base metal additive at various loadings.

Sample 12 is a separately prepared, additive-free, reference catalyst with the identical composition as Sample 1. Sample 12 was prepared by impregnating Rh nitrate solution on LZ to achieve a Rh loading of 0.5% by weight after calcination. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. The catalyst so obtained is designated as fresh catalyst.

Sample 13 was prepared by co-impregnating a mixed nitrate solution of Rh and Mg on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 0.25% MgO by weight. The catalyst so obtained is designated as fresh catalyst.

Sample 14 was prepared like sample 13 except that after calcination the catalyst contains 0.5% Rh by weight and 0.5% MgO by weight.

Sample 15 was prepared like sample 13 except that after calcination the catalyst contains 0.5% Rh by weight and 1.0% MgO by weight.

Sample 16 was prepared like sample 13 except that after calcination the catalyst contains 0.5% Rh by weight and 1.5% MgO by weight.

Sample 17 was prepared by co-impregnating a mixed nitrate solution of Rh and Fe on LZ.

The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 0.25% Fe₂O₃ by weight. The catalyst so obtained is designated as fresh catalyst.

Sample 18 was prepared was prepared like sample 17 except that after calcination the catalyst contains 0.5% Rh by weight and 0.5% Fe₂O₃ by weight.

Sample 19 was prepared was prepared like sample 17 except that after calcination the catalyst contains 0.5% Rh by weight and 1.0% Fe₂O₃ by weight.

Sample 20 was prepared was prepared like sample 17 except that after calcination the catalyst contains 0.50 Rh by weight and 1.5% Fe₂O₃ by weight.

Sample 21 was prepared by co-impregnating a mixed nitrate solution of Rh and Ni on LZ. The impregnated catalyst was dispersed in deionized water at about 300% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 0.25 NiO by weight. The catalyst so obtained is designated as fresh catalyst.

Sample 22 was prepared like sample 21 except that after calcination the catalyst contains 0.5% Rh by weight and 0.5% NiO by weight.

Sample 23 was prepared like sample 21 except that after calcination the catalyst contains 0.5% Rh by weight and 1.00 NiO by weight.

Sample was prepared like sample 21 except that after calcination the catalyst contains 0.50 Rh by weight and 1.500 NiO by weight.

TABLE 2
Catalyst compositions with 0.5% Rh: Effect of additive loading

| Sample | | Rh | | |
|---|---|---|---|---|
| ID | Sample Name | (wt. %) | Support | Additive |
| 12 | 0.5Rh/LZ | 0.5 | 9% La₂O₃, 91% ZrO₂ | N/A |
| 13 | 0.5Rh-0.25Mg/LZ | 0.5 | 9% La₂O₃, 91% ZrO₂ | 0.25% MgO |
| 14 | 0.5Rh-0.5Mg/LZ | 0.5 | 9% La₂O₃, 91% ZrO₂ | 0.5% MgO |
| 15 | 0.5Rh-1Mg/LZ | 0.5 | 9% La₂O₃, 91% ZrO₂ | 1% MgO |
| 16 | 0.5Rh-1.5Mg/LZ | 0.5 | 9% La₂O₃, 91% ZrO₂ | 1.5% MgO |
| 17 | 0.5Rh-0.25Fe/LZ | 0.5 | 9% La₂O₃, 91% ZrO₂ | 0.25% Fe₂O₃ |
| 18 | 0.5Rh-0.5Fe/LZ | 0.5 | 9% La₂O₃, 91% ZrO₂ | 0.5% Fe₂O₃ |
| 19 | 0.5Rh-1Fe/LZ | 0.5 | 9% La₂O₃, 91% ZrO₂ | 1% Fe₂O₃ |
| 20 | 0.5Rh-1.5Fe/LZ | 0.5 | 9% La₂O₃, 91% ZrO₂ | 1.5% Fe₂O₃ |
| 21 | 0.5Rh-0.25Ni/LZ | 0.5 | 9% La₂O₃, 91% ZrO₂ | 0.25% NiO |
| 22 | 0.5Rh-0.5Ni/LZ | 0.5 | 9% La₂O₃, 91% ZrO₂ | 0.5% NiO |
| 23 | 0.5Rh-1Ni/LZ | 0.5 | 9% La₂O₃, 91% ZrO₂ | 1% NiO |
| 24 | 0.5Rh-1.5NiFe/LZ | 0.5 | 9% La₂O₃, 91% ZrO₂ | 1.5% NiO |

### Example 3: Preparation of Catalyst Compositions with Low Rh (0.2%)

Table 3 lists catalyst compositions for catalysts with 0.2% Rh on LZ and a base metal additive at various loadings.

Sample 25 is an additive-free Rh reference catalyst, which was prepared by impregnating Rh nitrate solution on LZ to achieve a Rh loading of 0.2% by weight after calcination. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. The catalyst so obtained is designated as fresh catalyst.

Sample 26 was prepared by co-impregnating a mixed nitrate solution of Rh and Mg on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight and 0.25% MgO by weight. The catalyst so obtained is designated as fresh catalyst.

Sample 27 was prepared like sample 26 except that after calcination the catalyst contains 0.2% Rh by weight and 0.5% MgO by weight.

Samples 28 was prepared like sample 26 except that after calcination the catalyst contains 0.2% Rh by weight and 1.0% MgO by weight.

Sample 29 was prepared by co-impregnating a mixed nitrate solution of Rh and Fe on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight and 0.25% Fe₂O₃ by weight. The catalyst so obtained is designated as fresh catalyst.

Sample 30 was prepared like sample 29 except that after calcination the catalyst contains 0.2% Rh by weight and 0.5% Fe₂O₃ by weight.

Sample 31 was prepared like sample 29 except that after calcination the catalyst contains 0.2% Rh by weight and 1.0% Fe₂O₃ by weight.

Sample 32 was prepared by co-impregnating a mixed nitrate solution of Rh and Ni on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight and 0.25% NiO by weight. The catalyst so obtained is designated as fresh catalyst.

Sample 33 was prepared like sample 32 except that after calcination the catalyst contains 0.2% Rh by weight and 0.5% NiO by weight.

Sample 34 was prepared like sample 32 except that after calcination the catalyst contains 0.2% Rh by weight and 1.0% NiO by weight.

TABLE 3
Catalyst compositions with 0.2% Rh: Effect of additive loading

| Sample ID | Sample Name | Rh (wt. %) | Support | Additive |
|---|---|---|---|---|
| 25 | 0.2Rh/LZ | 0.2 | 9% La₂O₃, 91% ZrO₂ | N/A |
| 26 | 0.2Rh-0.25Mg/LZ | 0.2 | 9% La₂O₃, 91% ZrO₂ | 0.25% MgO |
| 27 | 0.2Rh-0.5Mg/LZ | 0.2 | 9% La₂O₃, 91% ZrO₂ | 0.5% MgO |
| 28 | 0.2Rh-1Mg/LZ | 0.2 | 9% La₂O₃, 91% ZrO₂ | 1% MgO |
| 29 | 0.2Rh-0.25Fe/LZ | 0.2 | 9% La₂O₃, 91% ZrO₂ | 0.25% Fe₂O₃ |
| 30 | 0.2Rh-0.5Fe/LZ | 0.2 | 9% La₂O₃, 91% ZrO₂ | 0.5% Fe₂O₃ |
| 31 | 0.2Rh-1Fe/LZ | 0.2 | 9% La₂O₃, 91% ZrO₂ | 1% Fe₂O₃ |
| 32 | 0.2Rh-0.25Ni/LZ | 0.2 | 9% La₂O₃, 91% ZrO₂ | 0.25% NiO |
| 33 | 0.2Rh-0.5Ni/LZ | 0.2 | 9% La₂O₃, 91% ZrO₂ | 0.5% NiO |
| 34 | 0.2Rh-1Ni/LZ | 0.2 | 9% La₂O₃, 91% ZrO₂ | 1% NiO |

### Example 4: Preparation of Catalyst Compositions with a Combination of Rh and Pt

Table 4 lists catalyst compositions for catalysts with Rh—Pt (0.5 wt. % Rh and 2 wt. % Pt or 0.2 wt. % Rh and 0.8 wt. % Pt) on LZ and a base metal additive. Samples 35 and 39 are additive-free Rh—Pt reference catalysts for catalysts containing 0.5% Rh-2% Pt and 0.2% Rh-0.8% Pt, respectively.

Sample 35 was prepared by co-impregnating mixed Rh—Pt nitrate solution on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 2% Pt by weight.

Sample 36 was prepared by co-impregnating mixed nitrate solution of Rh, Pt and Mg on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight, 2% Pt by weight and 1% MgO by weight.

Sample 37 was prepared by co-impregnating mixed nitrate solution of Rh, Pt and Fe on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight, 2% Pt by weight and 1% Fe₂O₃ by weight.

Sample 38 was prepared by co-impregnating mixed nitrate solution of Rh, Pt and Ni on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight, 2% Pt by weight and 1% NiO by weight.

Sample 39 was prepared by co-impregnating mixed Rh—Pt nitrate solution on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight and 0.8% Pt by weight.

Sample 40 was prepared by co-impregnating mixed nitrate solution of Rh, Pt and Mg on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight, 0.8% Pt by weight and 0.5% MgO by weight.

Sample 41 was prepared by co-impregnating mixed nitrate solution of Rh, Pt and Fe on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight, 0.8% Pt by weight and 0.5% Fe₂O₃ by weight.

Sample 42 was prepared by co-impregnating mixed nitrate solution of Rh, Pt and Ni on LZ. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.2% Rh by weight, 0.8% Pt by weight and 0.5% NiO by weight.

TABLE 4
Catalysts compositions with Rh and Pt

| Sample | | Rh | Pt | | |
|---|---|---|---|---|---|
| ID | Sample Name | (wt. %) | (wt. %) | Support | Additive |
| 35 | 0.5Rh-2Pt/LZ | 0.5 | 2 | 9% La₂O₃, 91% ZrO₂ | N/A |
| 36 | 0.5Rh-2Pt-1Mg/LZ | 0.5 | 2 | 9% La₂O₃, 91% ZrO₂ | 1% MgO |
| 37 | 0.5Rh-2Pt-1Fe/LZ | 0.5 | 2 | 9% La₂O₃, 91% ZrO₂ | 1% Fe₂O₃ |
| 38 | 0.5Rh-2Pt-1Ni/LZ | 0.5 | 2 | 9% La₂O₃, 91% ZrO₂ | 1% NiO |
| 39 | 0.2Rh-0.8Pt/LZ | 0.2 | 0.8 | 9% La₂O₃, 91% ZrO₂ | N/A |
| 40 | 0.2Rh-0.8Pt-0.5Mg/LZ | 0.2 | 0.8 | 9% La₂O₃, 91% ZrO₂ | 0.5% MgO |
| 41 | 0.2Rh-0.8Pt-0.5Fe/LZ | 0.2 | 0.8 | 9% La₂O₃, 91% ZrO₂ | 0.5% Fe₂O₃ |
| 42 | 0.2Rh-0.8Pt-0.5Ni/LZ | 0.2 | 0.8 | 9% La₂O₃, 91% ZrO₂ | 0.5% NiO |

### Example 5: Preparation of Catalyst Compositions with Rh, Promoter and Alumina as a Support

Table 5 lists catalyst compositions for catalysts with 0.5% Rh on an Al₂O₃ support and a base metal additive (Mg or Ni).

Sample 43 is an additive-free Rh reference catalyst, which was prepared by impregnating Rh nitrate solution on Al₂O₃ to achieve a Rh loading of 0.5% by weight after calcination. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. The catalyst so obtained is designated as fresh catalyst.

Sample 44 was prepared by co-impregnating a mixed nitrate solution of Rh and Mg on Al₂O₃. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 1% MgO by weight. The catalyst so obtained is designated as fresh catalyst.

Sample 45 was prepared by co-impregnating a mixed nitrate solution of Rh and Ni on Al₂O₃. The impregnated catalyst was dispersed in deionized water at about 30% solid content, milled for 10 min at 400 rpm, and then dried at 100° C. to obtain catalyst powder. The obtained powder was calcined at 550° C. in air for 2 hours, crashed and sieved to 250-500 mm. After calcination the catalyst contains 0.5% Rh by weight and 1% NiO by weight. The catalyst so obtained is designated as fresh catalyst.

TABLE 5
Alumina supported Rh catalyst compositions: Effect of promotors

| Sample | | Rh | | |
|---|---|---|---|---|
| ID | Sample Name | (wt. %) | Additive | Preparation method |
| 43 | 0.5Rh/Al₂O₃ | 0.5 | N/A | Rh impregnation |
| 44 | 0.5Rh-1Mg/Al₂O₃ | 0.5 | 1% MgO | Co-impregnation of |
| | | | | Rh-Mg |
| 45 | 0.5Rh-1Ni/Al₂O₃ | 0.5 | 1% NiO | Co-impregnation of |
| | | | | Rh-Ni |

### Example 6: Preparation of Catalyst Compositions with Pt, Promoter and Different Supports (Acid-Base Reactive Impregnation)

Table 6 lists three pairs of Pt catalysts supported on CeO₂/Al₂O₃(CA), La₂O₃/Al₂O₃(LZ) or CeO₂/ZrO₂/La₂O₃(CZL), respectively.

Sample 46 was prepared by impregnating platinum tetraethanolamine hydroxide solution on CA followed by impregnating a nitrate acid solution (about 3 wt. % of the support weight). The impregnation of the acid solution helps to fix Pt onto the support. The amount of Pt is 2% by weight after calcination. The impregnated catalyst was then dispersed in deionized water at about 30% solid content with pH adjusted to about 4.0 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 47 was prepared by first impregnating platinum tetraethanolamine hydroxide solution on CA followed by impregnating mixed solution of Fe nitrate and nitric acid. The amount of the acid in the mixed solution is equivalent to 3% of the support weight. After calcination, both Pt loading and Fe₂O₃ loading are 2% by weight. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 48 was prepared by impregnating platinum tetraethanolamine hydroxide solution on LZ followed by impregnating a nitrate acid solution (about 3 wt. % of the support weight). The amount of Pt is 2% by weight after calcination. The impregnated catalyst was then dispersed in deionized water at about 30% solid content with pH adjusted to about 4.0 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 49 was prepared by first impregnating platinum tetraethanolamine hydroxide solution on LZ followed by impregnating mixed solution of Ni nitrate and nitric acid. The amount of the acid in the mixed solution is equivalent to 3% of the support weight. After calcination, both Pt loading and NiO loading are 2% by weight. The impregnated catalyst was then dispersed in deionized water at about 30% solid content with pH adjusted to about 4.0 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 50 was prepared by impregnating platinum tetraethanolamine hydroxide solution on CZL followed by impregnating a nitrate acid solution (about 3 wt. % of the support weight). The amount of Pt is 2% by weight after calcination. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 51 was prepared by first impregnating platinum tetraethanolamine hydroxide solution on CZL followed by impregnating mixed solution of Mg nitrate and nitric acid. The amount of the acid in the mixed solution is equivalent to 3% of the support weight. After calcination, both Pt loading and MgO loading are 2% by weight. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

TABLE 6
Catalyst compositions with 2% Pt on various supports

| Sample ID | Sample Name | Pt (wt. %) | Additive | Support | Method |
|---|---|---|---|---|---|
| 46 | 2Pt/CA | 2 | N/A | 20% CeO₂, 80% Al₂O₃ | Acid-base reactive |
| | | | | | impregnation |
| 47 | 2Pt-2Fe/CA | 2 | 2% Fe₂O₃ | 20% CeO₂, 80% Al₂O₃ | Acid-base reactive |
| | | | | | impregnation |
| 48 | 2Pt/LZ | 2 | N/A | 9% La₂O₃, 91% ZrO₂ | Acid-base reactive |
| | | | | | impregnation |
| 49 | 2Pt-2Ni/LZ | 2 | 2% NiO | 9% La₂O₃, 91% ZrO₂ | Acid-base reactive |
| | | | | | impregnation |
| 50 | 2Pt/CZL | 2 | N/A | 86% CeO2, 10% ZrO2, | Acid-base reactive |
| | | | | 4% La₂O₃ | impregnation |
| 51 | 2Pt- | 2 | 2% MgO | 86% CeO2, 10% ZrO₂, | Acid-base reactive |
| | 2Mg/CZL | | | 4% La₂O₃ | impregnation |

Table 7 compiles Pt catalyst samples supported on La and Y doped Ce/Zr composite (40% CeO₂, 50% ZrO₂, 40% La₂O₃, 50% Y₂O₃). The support is designated as CZLY. Mg or Ni with different loadings was deposited on the Pt catalyst.

Sample 52 is the Pt reference sample, which was prepared by impregnating platinum tetraethanolamine hydroxide solution on CZLY followed by impregnating a nitrate acid solution (about 3 wt. % of the support weight). The impregnation of the acid solution helps to fix Pt onto the support. The amount of Pt is 2% by weight after calcination. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 53 was prepared by first impregnating platinum tetraethanolamine hydroxide solution on CZLY followed by impregnating mixed solution of Mg nitrate and nitric acid. The amount of the acid in the mixed solution is equivalent to 3% of the support weight. After calcination, Pt loading is 2% by weight and MgO loading is 1% by weight. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 54 was prepared like Sample 53 except that MgO loading is 2% by weight instead of 1%.

Sample 55 was prepared like Sample 53 except that MgO loading is 4% by weight instead of 1%.

Sample 56 was prepared by first impregnating platinum tetraethanolamine hydroxide solution on CZLY followed by impregnating mixed solution of Ni nitrate and nitric acid. The amount of the acid in the mixed solution is equivalent to 3% of the support weight. After calcination, Pt loading is 2% by weight and NiO loading is 1% by weight. The impregnated catalyst was then dispersed in deionized water at about 30% solid content with pH adjusted to about 4 using nitric acid. A boehmite alumina binder (about 5 wt. % of the catalyst) was added to the slurry. The slurry was dried at 100° C. to obtain a powder. The obtained powder was calcined at 550° C. in air for 2 hours, crashed and sieved to 250-500 mm. The catalyst so obtained is designated as fresh catalyst.

Sample 57 was prepared like Sample 56 except that NiO loading is 2% by weight instead of 1%.

Sample 58 was prepared like Sample 56 except that NiO loading is 4% by weight instead of 1%.

TABLE 7
Catalyst compositions with 2% Pt on La/Y doped Ce/Zr composite (CZLY)

| Sample | | Pt | | | |
|---|---|---|---|---|---|
| ID | Sample Name | (wt. %) | Additive | Support | Method |
| 52 | 2Pt/CZLY | 2 | N/A | 40% CeO₂, 50% ZrO₂, 4% | Acid-base reactive |
| | | | | La₂O₃, 5% Y₂O₃ | impregnation |
| 53 | 2Pt-1Mg/CZLY | 2 | 1% MgO | 40% CeO₂, 50% ZrO₂, 4% | Acid-base reactive |
| | | | | La₂O₃, 5% Y₂O₃ | impregnation |
| 54 | 2Pt-2Mg/CZLY | 2 | 2% MgO | 40% CeO₂, 50% ZrO_{2,} 4% | Acid-base reactive |
| | | | | La₂O₃, 5% Y₂O₃ | impregnation |
| 55 | 2Pt-4Mg/CZLY | 2 | 4% MgO | 40% CeO₂, 50% ZrO₂, 4% | Acid-base reactive |
| | | | | La₂O₃, 5% Y₂O₃ | impregnation |
| 56 | 2Pt-1Ni/CZLY | 2 | 1% NiO | 40% CeO₂, 50% ZrO₂, 4% | Acid-base reactive |
| | | | | La₂O₃, 5% Y₂O₃ | impregnation |
| 57 | 2Pt-2Ni/CZLY | 2 | 2% NiO | 40% CeO₂, 50% ZrO₂, 4% | Acid-base reactive |
| | | | | La₂O₃, 5% Y₂O₃ | impregnation |
| 58 | 2Pt-4Ni/CZLY | 2 | 4% NiO | 40% CeO₂, 50% ZrO₂, 4% | Acid-base reactive |
| | | | | La₂O₃, 5% Y₂O₃ | impregnation |

### Example 7: Evaluation of Prepared Catalysts

### Catalyst Evaluation Protocol

All catalysts were aged at 1050° C. for 5 hrs. with 10% H₂O under an alternating lean/rich feed (10 minutes 4% air/10 minutes 4% H₂/N₂). The aged catalysts were evaluated in a powder reactor using a light-off protocol with a λ=1 oscillating feed (λ=0.95/1.05 cycled at 1 Hz) from 175 to 450° C. at a monolith equivalent GHSV of 70,000 h⁻¹. For light-off tests, the lean feed (λ=1.05) consists of 0.7% CO, 0.22% H₂, 3000 ppm HC (C1) (propene:propane=2:1), 1500 ppm NO, 14% CO₂, 10% H₂O and ~1.8% O₂. The rich feed (λ=0.95) includes 2.33% CO, 0.77% H₂, 3000 ppm HC (C1), 1500 ppm NO, 14% CO₂, 10% H₂O and ~0.7% O₂. The exact lambda values are fine-tuned by adjusting the O₂ level based on an upstream λ-sensor. Two consecutive light-off runs were performed. The first light-off run is used as catalyst de-greening (or stabilization), and the second light-off data are used for activity comparison. The concentrations of carbon monoxide (CO), nitric oxide (NO) and hydrocarbon (HC) were continuously measured before and after catalysts. The conversion of a component (CO, NO or HC) is calculated as the percent of disappearance, i.e., Conversion=(Inlet concentration—Outlet concentration)/Inlet concentration×100%. Catalyst activity is also characterized by catalyst light-off temperature, which is defined as the temperature required to achieve 50% conversion in a conversion—temperature plot. Light-off temperature is denoted as T50. Light-off temperatures for CO, NO and HC are expressed as CO T50, NO T50 and HC T50, respectively.

In addition to catalyst light-off activity, selected samples that are supported on Ce/Zr composite were evaluated for oxygen storage capacity (or OSC). OSC was measured at 350 and 450° C. with alternating reducing/oxidizing pulses. Specifically, alternating 2% CO/N₂ pulses (10 s) and 1% O₂/N₂ pulses (10 s) were applied to a sample at a target temperature for 15 cycles with one cycle consisting of one CO pulse and one O₂ pulse. When a CO pulse contacts an oxidized catalyst, CO is consumed by reacting with the lattice oxygen of the catalyst. When an O₂ pulse contacts a reduced catalyst, some oxygen is consumed by filling the oxygen vacancies within the catalyst. The CO consumption is integrated and averaged for 15 cycles, which is considered as the measured oxygen storage capacity.

The detailed comparative results are shown in the accompanying figures.

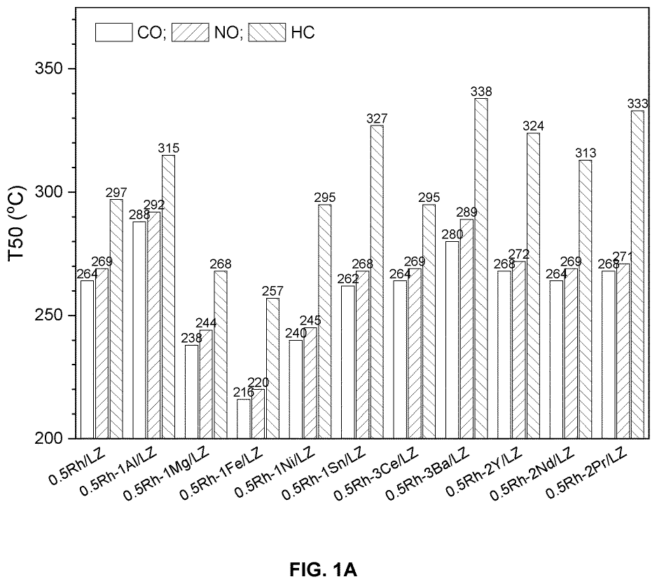

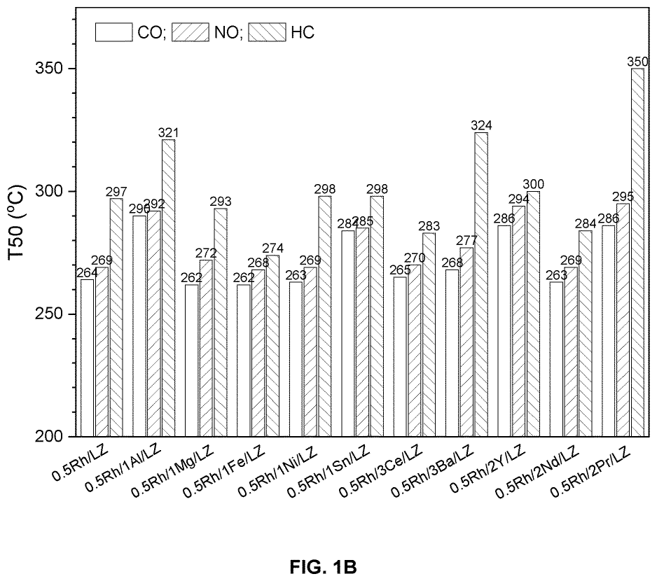

FIG. 1A shows the T50s for CO, NO and HC of the LZ supported 0.5 wt. % Rh catalysts with different additives prepared by co-impregnation (catalysts shown in Table 1A). The catalysts containing Mg, Fe and Ni show substantially lower T50s for CO, NO and HC compared to the additive-free Rh reference catalyst or to any of the catalysts containing Sn, Pr, Ce, Ba, Y or Nd.

FIG. 1B shows the T50s for CO, NO and HC of the LZ supported 0.5 wt. % Rh catalysts with different additives prepared by sequential impregnation (catalysts shown in Table 1B). For CO and HC performance, none of the promotor-containing catalysts show better performance than the promotor-free Rh reference catalyst. For NO performance, some advantage was observed on catalysts containing Fe, Ce, or Pr promotor relative to the Rh reference. Overall, sequential impregnation method shows inferior catalytic performance compared to co-impregnation method for a given catalyst composition. This difference is especially obvious for the Rh catalysts promoted by Fe, Mg or Ni.

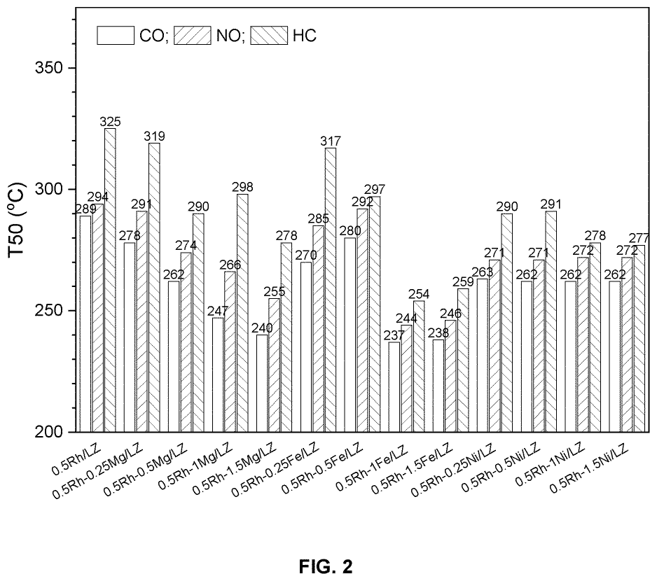

FIG. 2 shows the T50s for CO, NO and HC of the LZ supported 0.5 wt. % Rh catalysts with different loadings of Mg, Fe and Ni prepared by co-impregnation (catalysts shown in Table 2). For 0.5Rh-xMg/LZ catalysts, with 1.5 wt. % MgO the catalyst shows the lowest T50 for CO, NO and HC. For 0.5 Rh-xFe/LZ catalysts, 1 wt. % and 1.5 wt. % Fe₂O₃ provide comparable performance improvements and are the best Fe loading within this range. All Ni-containing catalysts show improvement relative to the refence Rh catalyst, but no strong dependence found on Ni loading.

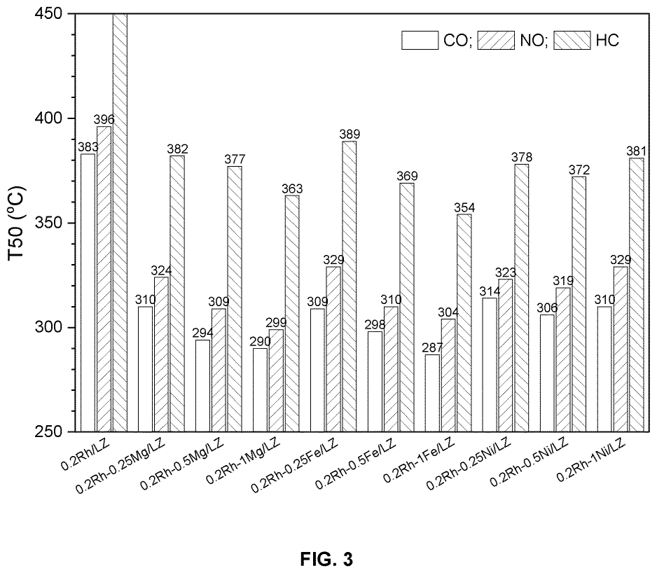

FIG. 3 shows the T50s for CO, NO and HC of the LZ supported 0.2 wt. % Rh catalysts with different loadings of Mg, Fe and Ni prepared by co-impregnation (catalysts shown in Table 3). For 0.2Rh-xMg/LZ catalysts, with 1 wt. % MgO the catalyst shows the lowest T50 for CO, NO and HC. For 0.2Rh-xFe/LZ catalysts, 1 wt. % Fe₂O₃ is the optimal Fe loading. All Ni-containing catalysts show improvement relative to the refence Rh catalyst, with no obvious dependence on Ni loading.

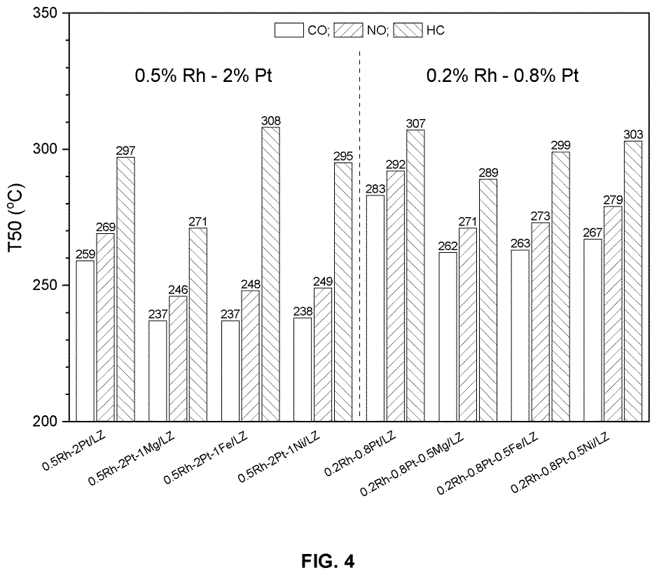

FIG. 4 shows the T50s for CO, NO and HC of the LZ supported Rh—Pt catalysts (0.5 wt. % Rh+2 wt. % Pt and 0.2 wt. % Rh+0.8 wt. % Pt) with Mg, Fe or Ni prepared by co-impregnation (catalysts shown in Table 4). With either Rh/Pt composition, a catalyst containing either Mg, Fe or Ni shows performance improvement relative to its corresponding Rh/Pt reference. The Rh/Pt catalysts modified with Mg show the largest improvements amongst other catalysts.

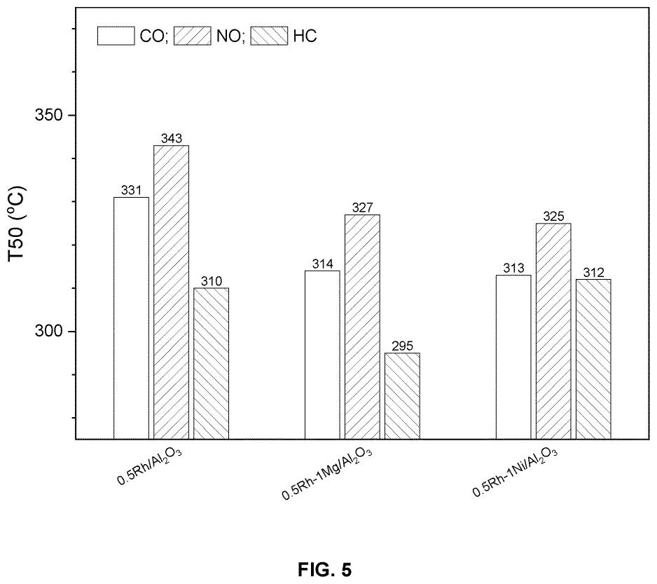

FIG. 5 shows the T50s for CO, NO and HC of the Al₂O₃ supported 0.5 wt. % Rh catalysts with Mg and Ni prepared by co-impregnation (catalysts shown in Table 5). The catalyst containing 1% MgO shows lower T50s for all conversions than that of the additive-free Rh reference catalyst. The catalyst containing 1% NiO shows lower T50s for CO and NO but is comparable for HC.

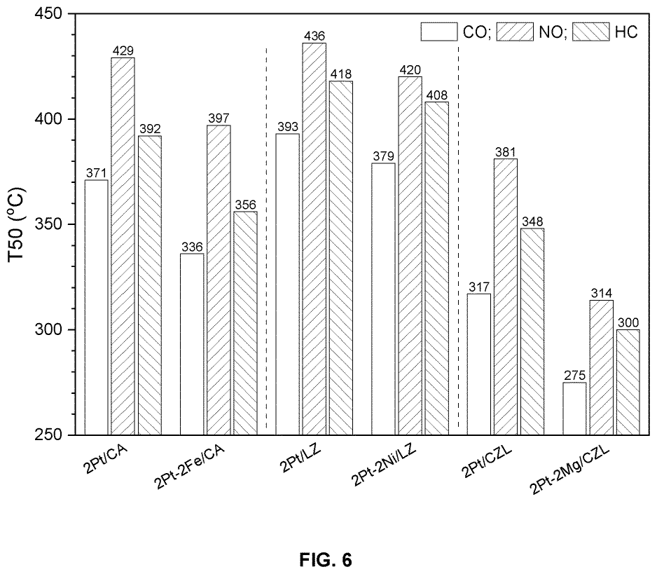

FIG. 6 shows the T50s for CO, NO and HC of three pairs of Pt catalysts prepared by acid-base reactive impregnation (catalysts shown in Table 6). For CA supported Pt catalysts, 2Pt-2Fe/CA has lower T50s than 2Pt/CA. For LZ supported Pt catalysts, 2Pt-2Ni/LZ shows lower T50s relative to 2Pt/LZ. For CZL supported Pt catalysts, 2Pt-2Mg/CZL significantly outperforms 2Pt/CZL.

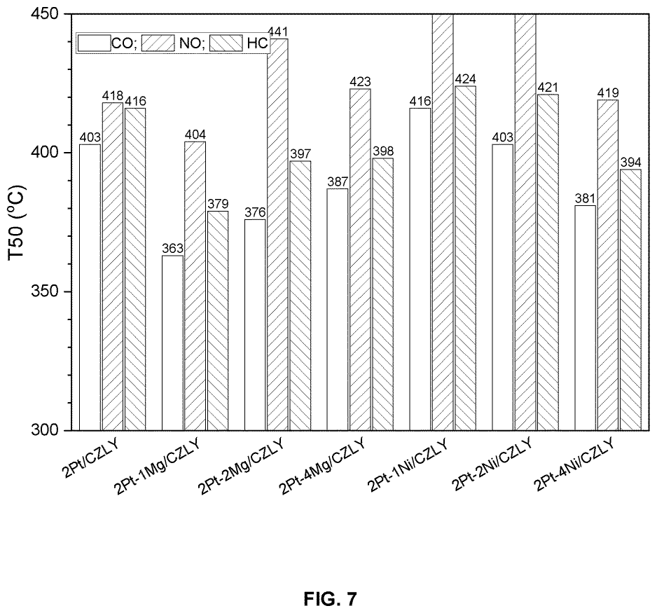

FIG. 7 shows the T50s of the samples supported on CZLY prepared by acid-base reactive impregnation (Sample 52 to 58 shown in Table 7). For 2Pt-xMg/CZLY catalysts, the sample with 1% MgO shows the lowest T50 for CO, NO and HC relative to the dopant-free Pt reference. For 2Pt-xNi/CZLY catalysts, the sample with 4% NiO shows the best performance.

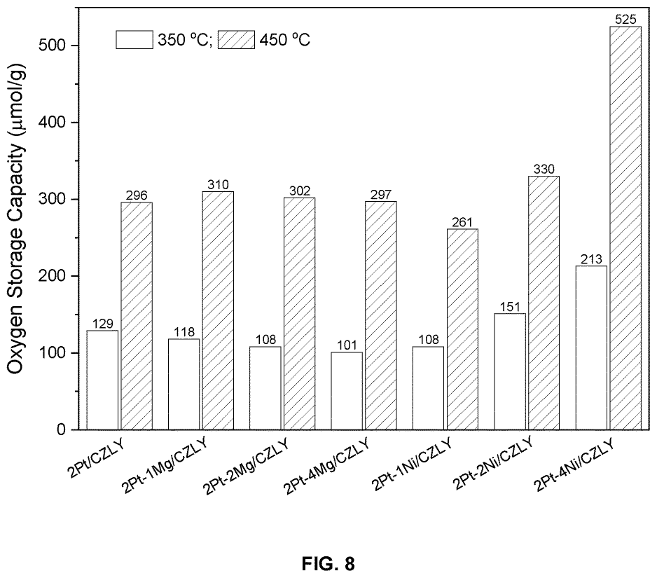

FIG. 8 shows the oxygen storage capacities of the CZLY supported Pt samples measured at 350 and 450° C. For Ni containing sample, there is a sudden increase in OSC when NiO loading increases from 2 to 4% by weight. Relative to the dopant-free Pt reference (Sample (52), the sample with 4% NiO increased OSC by 65 and 77% at 350 and 450° C., respectively.

The comparative results for Rh using co-impregnation technique versus sequential impregnation technique are further provided in the following Tables 8A-8C.

TABLE 8A
Single PGM (Rh): Co-impregnation & sequential impregnation: T50(° C.)

| Rh on LZ support (with or without Mg as a promoter) | CO | NO | HC |
|---|---|---|---|
| Without promoter (0.5Rh-LZ) | 264 | 269 | 297 |
| Sequential impregnation(0.5Rh/1Mg-LZ) | 262 | 272 | 293 |
| Co-impregnation(0.5Rh-1Mg-LZ) | 238 | 244 | 268 |

TABLE 8B
Single PGM (Rh): Co-impregnation & sequential impregnation: T50(° C.)

| Rh on LZ support (with or without Fe as a promoter) | CO | NO | HC |
|---|---|---|---|
| Without promoter (0.5Rh-LZ) | 264 | 269 | 297 |
| Sequential impregnation(0.5Rh/1Fe-LZ) | 262 | 268 | 274 |
| Co-impregnation(0.5Rh-1Fe-LZ) | 216 | 220 | 257 |

TABLE 8C
Single PGM (Rh): Co-impregnation & sequential impregnation: T50(° C.)

| Rh on LZ support (with or without Ni as promoter) | CO | NO | HC |
|---|---|---|---|
| Without promoter (0.5Rh-LZ) | 264 | 269 | 297 |
| Sequential impregnation(0.5Rh/1Ni-LZ) | 263 | 269 | 298 |
| Co-impregnation(0.5Rh-1Ni-LZ) | 240 | 245 | 295 |

The results shows that the promoters like Mg, Fe and Ni gives reduced T50(° C.) for Rh. The best results are found when co-impregnation technique was used.

The catalyst compositions of the presently claimed invention when prepared using co-impregnation technique or acid-base interactive impregnation technique are surprisingly effective in reducing the T50(° C.) for CO, NO and HC conversion. Without wishing to be bound to a theory, co-impregnation and acid-base reactive impregnation enhance the interaction between PGM and promotor(s) by positioning them in a close proximity. Sequential impregnation (promotor first and PGM second), on the other hand, will likely result in a strong promotor-support interaction with minimum modification of PGM. An example of this interaction is Ni—Al₂O₃ (or any other transition metal promotors) interaction. After a high temperature aging, Ni and alumina will form a spinel, which has a much lower surface area.

Further, the redox property of PGM is enhanced by co-impregnation due to the close interaction between PGM and transition metal promotor. That is, after a reduction treatment/exposure, a catalyst made by this invention becomes more active. Sequential impregnation will preferentially form spinel between promotor and support.

The comparative results for Pt using co-impregnation technique are provided in the following Tables 9A-9C.

TABLE 9A
Single PGM (Pt): Co-impregnation: T50(° C.)

| Pt on CA support | | | |
|---|---|---|---|
| (with or without promoter) | CO | NO | HC |
| Without promoter (2Pt-CA) | 371 | 429 | 392 |
| Co-impregnation(2Pt-2Fe-CA) | 336 | 397 | 356 |

TABLE 9B
Single PGM (Pt): Co-impregnation: T50(° C.)

| Pt on LZ support | | | |
|---|---|---|---|
| (with or without promoter) | CO | NO | HC |
| Without promoter (2Pt-LZ) | 393 | 436 | 418 |
| Co-impregnation(2Pt-2Ni-LZ) | 379 | 420 | 408 |

TABLE 9C
Single PGM (Pt): Co-impregnation: T50(° C.)

| Pt on CZL support | | | |
|---|---|---|---|
| (with or without promoter) | CO | NO | HC |
| Without promoter (2Pt-CZL) | 317 | 381 | 348 |
| Co-impregnation(2Pt-2Mg-CZL) | 275 | 314 | 300 |

The results shows that the promoters like Mg, Fe and Ni gives reduced T50(° C.) for Pt when co-impregnation technique was used.

The comparative results for Pt using Acid-base reactive impregnation technique are provided in the following Table 10A.

TABLE 10A
Single PGM (Pt): Acid-base reactive impregnation: T50(° C.)

| Pt on CZLY support (with or without promoter) | CO | NO | HC |
|---|---|---|---|
| Without promoter (2Pt-CZLY) | 403 | 418 | 416 |
| Acid-base impregnation(2Pt-4Ni-CZLY) | 381 | 419 | 394 |
| Acid-base impregnation(2Pt-1Mg-CZLY) | 363 | 404 | 379 |

The results shows that the promoters like Mg and Ni gives reduced T50(° C.) for Pt when acid-base reactive impregnation technique was used.

The comparative results for a combination of Pt and Rh using co-impregnation technique are provided in the following Table 10B.

TABLE 10B
Two PGM (Rh+Pt): co-impregnation: T50(° C.)

| Pt/Rh on lanthana-zirconia support | | | |
|---|---|---|---|
| (with or without promoter) | CO | NO | HC |
| Without promoter (0.5Rh + 2Pt-LZ) | 259 | 269 | 297 |
| Co-impregnation(0.5Rh + 2Pt-1Mg-LZ) | 237 | 246 | 271 |
| Co-impregnation(0.5Rh + 2Pt-1Fe-LZ) | 237 | 248 | 308 |
| Co-impregnation(0.5Rh + 2Pt-1Ni-LZ) | 238 | 249 | 295 |

The results shows that the promoters like Mg, Fe and Ni gives reduced T50(° C.) for a combination of Pt and Rh when co-impregnation technique was used.

The present invention is further illustrated by the following set of embodiments and combinations of embodiments resulting from the dependencies and back-references as indicated. In particular, it is noted that in each instance where a range of embodiments is mentioned, for example in the context of a term such as “The catalyst composition of any one of embodiments 1 to 4”, every embodiment in this range is meant to be explicitly disclosed for the skilled person, i.e. the wording of this term is to be understood by the skilled person as being synonymous to “The catalyst composition of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.

### Embodiment 1

The catalyst composition comprising:
a) a platinum group metal comprising rhodium, platinum or a combination thereof,
b) a metal-oxide promoter, wherein the metal in the metal-oxide promoter is selected from magnesium, iron, nickel or any combination thereof, and
c) a support,
   wherein the total amount of the platinum group metal is in the range of 0.1 to 10 wt. %, based on the total weight of the catalyst composition,
   wherein the total amount of the promoter, in an oxide form is in the range of 0.2 to 6.0 wt. %, based on the total weight of the catalyst composition,
   wherein the total amount of support is in the range of 84 to 99.3 wt. %, based on the total weight of the catalyst composition,
   wherein the support is selected from a rare earth metal-oxide doped zirconia solid solution, a ceria-alumina composite, rare earth metal-oxide doped ceria-zirconia solid solution or a combination thereof,
   wherein the platinum group metal and promoter are co-impregnated on the support or acid-base reactive impregnated on the support.

### Embodiment 2

The catalyst composition according to embodiment 1, wherein the rare earth metal in the rare earth metal-oxide doped zirconia composite or the rare earth metal-oxide doped ceria-zirconia solid solution is selected from lanthanum, praseodymium, neodymium, yttrium, or any combination thereof.

### Embodiment 3

The catalyst composition according to embodiment 2, wherein the rare earth metal in the rare earth meal oxide doped zirconia solid solution or the rare earth metal-oxide doped ceria-zirconia solid solution is lanthanum.

### Embodiment 4

The catalyst composition according to any of embodiments 1 to 3, wherein the platinum group metal is rhodium.

### Embodiment 5

The catalyst composition according to embodiment 4, wherein the amount of rhodium is in the range of 0.1 to 2.0 wt. %, based on the total weight of the catalyst composition.

### Embodiment 6

The catalyst composition according to any of embodiments 1 to 3, wherein the platinum group metal is platinum.

### Embodiment 7

The catalyst composition according to embodiment 6, wherein the amount of platinum is in the range of 0.2 to 4.0 wt. %, based on the total weight of the catalyst composition.

### Embodiment 8

The catalyst composition according to any of embodiments 1 to 3, wherein the platinum group metal is a combination of rhodium and platinum.

### Embodiment 9

The catalyst composition according to embodiment 8, wherein the weight ratio of rhodium to platinum is 1:0.5 to 1:10.

### Embodiment 10

The catalyst composition according to any of embodiments 1 to 5, wherein the platinum group metal is rhodium, and the metal in the metal-oxide promoter is magnesium.

### Embodiment 11

The catalyst composition according to any of embodiments 1 to 3, wherein the platinum group metal is platinum, and the metal in the metal-oxide promoter is magnesium.

### Embodiment 12

The catalyst composition according to any of embodiments 1 to 3 or 8 to 9, wherein the platinum group metal is a combination of rhodium and platinum, and the promoter is magnesium.

### Embodiment 13

The catalyst composition according to any of embodiments 1 to 5, wherein the platinum group metal is rhodium, and the metal in the metal-oxide promoter is iron.

### Embodiment 14

The catalyst composition according to any of embodiments 1 to 3, wherein the platinum group metal is platinum, and the promoter is iron.

### Embodiment 15

The catalyst composition according to any of embodiments 1 to 3 or 8 to 9, wherein the platinum group metal is a combination of rhodium and platinum, and the metal in the metal-oxide promoter is iron.

### Embodiment 16

The catalyst composition according to any of embodiments 1 to 5, wherein the platinum group metal is rhodium, and the metal in the metal-oxide promoter is nickel.

### Embodiment 17

The catalyst composition according to any of embodiments 1 to 3, wherein the platinum group metal is platinum, and the metal in the metal-oxide promoter is nickel.

### Embodiment 18

The catalyst composition according to any of embodiments 1 to 3 or 8 to 9, wherein the platinum group metal is a combination of rhodium and platinum, and the metal in the metal-oxide promoter is nickel.

### Embodiment 19

The catalyst composition according to embodiment 1, the support is a rare earth metal-oxide doped zirconia, wherein the rare earth metal is lanthanum.

### Embodiment 20

The catalyst composition according to any of embodiments 1 to 19, wherein the amount of rare earth metal in an oxide form in the rare earth metal doped zirconia solid solution is in the range of 5.0 to 15 wt. %, based on the total weight of the rare earth metal-oxide doped zirconia solid solution and the amount of zirconia in the rare earth metal-oxide doped zirconia solid solution is in the range of 85 to 95 wt. %, based on the total weight of the rare earth metal-oxide doped zirconia solid solution.

### Embodiment 21

The catalyst composition according to any of embodiments 1 to 19, wherein the amount of rare earth metal in an oxide form in the rare earth metal doped ceria-zirconia solid solution is in the range of 5.0 to 15 wt. %, based on the total weight of the rare earth metal-oxide doped zirconia solid solution and the amount of ceria-zirconia in the rare earth metal-oxide doped zirconia solid solution is in the range of 85 to 95 wt. %, based on the total weight of the rare earth metal-oxide doped ceria-zirconia solid solution.

### Embodiment 22

The catalyst composition according to any of embodiments 1 to 21, wherein the total amount of the promoter, in an oxide form is in the range of 0.2 to 5 wt. %, preferably in the range of 0.2 to 4.0 wt. %, more preferably in the range of 0.2 to 3.0 wt. %, more preferably in the range of 0.2 to 2.0 wt. %, more preferably in the range of 0.5 to 2.0 wt. %, based on the total weight of the catalyst composition.

### Embodiment 23

The process for the preparation of the catalyst composition according to any of embodiments 1 to 22, wherein the process comprises the following steps:
mixing a platinum group metal salt and a metal-oxide promoter salt to obtain a mixture;
co-impregnating the mixture on the support selected from rare earth metal doped oxide zirconia solid solution, a ceria-alumina composite, rare earth metal-oxide doped ceria-zirconia solid solution or a combination thereof to obtain an impregnated support,
calcination of the impregnated support to obtain the catalyst composition.

### Embodiment 24

The process for the preparation of the catalyst composition according to any of embodiments 1 to 22, wherein the process comprises the following steps:
impregnating a basic platinum precursor solution on the support to obtain a first impregnated support;
impregnating an acidified metal-oxide promotor salt solution on the first impregnated support to obtain a second impregnated support; and
calcination of the second impregnated support to obtain the catalyst composition.

### Embodiment 25

The process according to any of embodiments 23 to 24, wherein the process comprises dispersing the impregnated support or the second impregnated support in deionized water at about 30% to 40% solid content followed by milling.

### Embodiment 26

A catalytic article comprising the catalyst composition according to any of embodiments 1-22 deposited on at least parts of a substrate.

### Embodiment 27

The catalytic article according to embodiment 26, wherein the catalytic article is a single layered article, wherein the catalyst composition according to any of embodiments 1 to 22 is deposited as a single layer on the at least parts of the substrate.

### Embodiment 27

The catalytic article according to embodiment 26, wherein the catalytic article is a bi-layered article comprising a first layer, a second layer and a substrate, wherein the first layer is deposited on at least parts of the substrate and the second layer is deposited on at least parts of the first layer and/or at least on parts of the substrate, wherein the first layer comprises platinum, palladium, rhodium or any combination thereof, wherein the second layer comprises the catalyst composition according to any of embodiments 1 to 22.

### Embodiment 29

The method of reducing hydrocarbons, carbon monoxide, and nitrogen oxide levels in a gaseous exhaust stream, the method comprising contacting a gaseous exhaust stream with the catalytic article according to any of embodiments 26 to 28 to reduce the levels of hydrocarbons, carbon monoxide, and nitrogen oxide in the exhaust gas.

### Embodiment 30

Use of the catalytic article according to any of embodiments 26 to 28 for purifying a gaseous exhaust stream comprising hydrocarbons, carbon monoxide, and nitrogen oxide.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation.

1. A catalyst composition comprising:
a) a platinum group metal comprising rhodium, platinum, or a combination thereof,
b) a metal-oxide promoter, wherein the metal in the metal-oxide promoter is selected from magnesium, iron, nickel, or any combination thereof, and
c) a support,
wherein the total amount of the platinum group metal is in the range of 0.1 to 10 wt. %, based on the total weight of the catalyst composition,
wherein the total amount of the promoter, in an oxide form is in the range of 0.2 to 6.0 wt. %, based on the total weight of the catalyst composition,
wherein the total amount of support is in the range of 84 to 99.3 wt. %, based on the total weight of the catalyst composition,
wherein the support is selected from a rare earth metal-oxide doped zirconia solid solution, a ceria-alumina composite, rare earth metal-oxide doped ceria-zirconia solid solution or a combination thereof,
wherein the platinum group metal and promoter are co-impregnated on the support or acid-base reactive impregnated on the support.

2. The catalyst composition according to claim 1, wherein the rare earth metal in the rare earth metal-oxide doped zirconia solid solution or the rare earth metal-oxide doped ceria-zirconia solid solution is selected from lanthanum, praseodymium, neodymium, yttrium, or any combination thereof, wherein the rare earth metal in the rare earth metal oxide doped zirconia solid solution or the rare earth metal-oxide doped ceria-zirconia solid solution is lanthanum.

3. (canceled)

4. The catalyst composition according to claim 1, wherein the platinum group metal is rhodium, wherein the amount of rhodium is in the range of 0.1 to 2.0 wt. %, based on the total weight of the catalyst composition.

5. (canceled)

6. The catalyst composition according to any claim 1, wherein the platinum group metal is platinum, wherein the amount of rhodium is in the range of 0.2 to 4.0 wt. %, based on the total weight of the catalyst composition.

7. (canceled)

8. The catalyst composition according to claim 1, wherein the platinum group metal is a combination of rhodium and platinum, wherein the weight ratio of rhodium to platinum is 1:0.5 to 1:10.

9. (canceled)

10. The catalyst composition according to claim 1, wherein the platinum group metal is rhodium, and the metal in the metal-oxide promoter is magnesium, iron, or nickel.

11. The catalyst composition according to claim 1, wherein the platinum group metal is platinum, and the metal in the metal-oxide promoter is magnesium, iron, or nickel.

12. The catalyst composition according to claim 1, wherein the platinum group metal is a combination of rhodium and platinum, and the metal in the metal-oxide promoter is magnesium, iron, or nickel.

13-18. (canceled)

19. The catalyst composition according to claim 1, wherein the support is a rare earth metal-oxide doped zirconia, wherein the rare earth metal is lanthanum.

20. The catalyst composition according to claim 1, wherein the amount of rare earth metal in an oxide form in the rare earth metal doped zirconia solid solution is in the range of 5.0 to 15 wt. %, based on the total weight of the rare earth metal-oxide doped zirconia solid solution and the amount of zirconia in the rare earth metal-oxide doped zirconia solid solution is in the range of 85 to 95 wt. %, based on the total weight of the rare earth metal-oxide doped zirconia solid solution.

21. The catalyst composition according to claim 1, wherein the amount of rare earth metal in an oxide form in the rare earth metal doped ceria-zirconia solid solution is in the range of 5.0 to 15 wt. %, based on the total weight of the rare earth metal-oxide doped zirconia solid solution and the amount of ceria-zirconia in the rare earth metal-oxide doped zirconia solid solution is in the range of 85 to 95 wt. %, based on the total weight of the rare earth metal-oxide doped ceria-zirconia solid solution.

22. The catalyst composition according to claim 1, wherein the total amount of the promoter, in an oxide form is in the range of 0.2 to 2.0 wt. %, based on the total weight of the catalyst composition.

23. A process for the preparation of the catalyst composition according to claim 1, wherein the process comprises the following steps:
mixing a platinum group metal salt and a metal-oxide promoter salt to obtain a mixture;
co-impregnating the mixture on the support selected from rare earth metal doped oxide zirconia solid solution, a ceria-alumina composite, rare earth metal-oxide doped ceria-zirconia solid solution or a combination thereof to obtain an impregnated support,
calcination of the impregnated support to obtain the catalyst composition.

24. A process for the preparation of the catalyst composition according to claim 1, wherein the process comprises the following steps:
impregnating a basic platinum precursor solution on the support to obtain a first impregnated support;
impregnating an acidified metal-oxide promotor salt solution on the first impregnated support to obtain a second impregnated support; and
calcination of the second impregnated support to obtain the catalyst composition.

25. The process according to claim 23, wherein the process comprises dispersing the impregnated support or the second impregnated support in deionized water at about 30% to 40% solid content followed by milling.

26. A catalytic article comprising the catalyst composition according to claim 1 deposited on at least parts of a substrate.

27. A catalytic article comprising the catalyst composition according to claim 1 deposited on at least parts of a substrate, wherein the catalytic article is a single layered article, wherein the catalyst composition is deposited as a single layer on the at least parts of the substrate.

28. A catalytic article comprising the catalyst composition according to claim 1 deposited on at least parts of a substrate, wherein the catalytic article is a bi-layered article comprising a first layer, a second layer and a substrate, wherein the first layer is deposited on at least parts of the substrate and the second layer is deposited on at least parts of the first layer and/or at least on parts of the substrate, wherein the first layer comprises platinum, palladium, rhodium or any combination thereof, wherein the second layer comprises the catalyst composition.

29. A method of reducing hydrocarbons, carbon monoxide, and nitrogen oxide levels in a gaseous exhaust stream, the method comprising contacting a gaseous exhaust stream with the catalytic article according to claim 26 to reduce the levels of hydrocarbons, carbon monoxide, and nitrogen oxide in the exhaust gas.

30. A use of the catalytic article according to claim 26 for purifying a gaseous exhaust stream comprising hydrocarbons, carbon monoxide, and nitrogen oxide.
